(19) United States
(12) Patent Application Publication
(10) Pub. No.: US 2024/0311584 A1
(43) Pub. Date: Sep. 19, 2024

(54) TEXT TRANSLATION METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Hui JIANG, Shenzhen (CN); Ziyao LU, Shenzhen (CN); Fandong MENG, Shenzhen (CN); Jinsong SU, Shenzhen (CN)

(21) Appl. No.: 18/671,618

(22) Filed: May 22, 2024

Related U.S. Application Data
(63) Continuation of application No. PCT/CN2023/100947, filed on Jun. 19, 2023.

(30) Foreign Application Priority Data
Aug. 30, 2022 (CN) 202211049110.8

(51) Int. Cl. G06F 40/45

(52) U.S. Cl. CPC G06F 40/45

(57) ABSTRACT

A text translation method includes determining at least one first probability based on a first text feature of a first text in a first language to indicate probabilities that the first text is translated into various candidate texts in a second language; obtaining at least one target data-pair matching the first text feature, a target data-pair comprising one second text feature and one standard translation text of second text, the second text being in the first language, and the standard translation text being in the second language; determining confidences and matching degrees of the at least one target data-pair; determining at least one second probability to indicate probabilities that the first text is translated into various standard translation texts in the at least one target data-pair; and determining a translation text corresponding to the first text.

### CROSS-REFERENCES TO RELATED APPLICATIONS

This application is a continuation application of PCT Patent Application No. PCT/CN2023/100947, filed on Jun. 19, 2023, which claims priority to Chinese Patent Application No. 202211049110.8, filed on Aug. 30, 2022, all of which is incorporated herein by reference in their entirety.

### FIELD OF THE TECHNOLOGY

Embodiments of the present disclosure relate to the field of computer technologies and, in particular, to a text translation method, computer device, and storage medium.

### BACKGROUND OF THE DISCLOSURE

With the development of computer technologies, application scenarios of text translation, by which a text in one language can be translated into a text in another language, are increasingly widespread. How to improve the accuracy of text translation is a technical problem to be urgently solved.

### SUMMARY

Embodiments of the present disclosure provide a text translation method, applied to a computer device. The method includes determining at least one first probability based on a first text feature, the first text feature being a text feature of a first text, the first text being a text in a first language, the at least one first probability indicating probabilities that the first text is translated into various candidate texts of at least one candidate text, and the at least one candidate text being a text in a second language; obtaining at least one target data-pair matching the first text feature, a target data-pair comprising one second text feature and one standard translation text of a second text, the second text feature being a text feature of the second text, the second text being the text in the first language, and the standard translation text being the text in the second language; determining confidences and matching degrees of the at least one target data-pair, a confidence of the target data-pair indicating reliability of the target data-pair, and a matching degree of the target data-pair indicating similarity of the second text feature in the target data-pair with the first text feature; determining at least one second probability based on the confidences and the matching degrees of the at least one target data-pair, the at least one second probability indicating probabilities that the first text is translated into various standard translation texts in the at least one target data-pair; and determining, based on the at least one first probability and the at least one second probability, a translation text corresponding to the first text.

Embodiments of the present disclosure provide a computer device. The computer device includes one or more processors and a memory containing at least one computer program that, when being executed, causes the one or more processors to perform: determining at least one first probability based on a first text feature, the first text feature being a text feature of a first text, the first text being a text in a first language, the at least one first probability indicating probabilities that the first text is translated into various candidate texts of at least one candidate text, and the at least one candidate text being a text in a second language; obtaining at least one target data-pair matching the first text feature, a target data-pair comprising one second text feature and one standard translation text of a second text, the second text feature being a text feature of the second text, the second text being the text in the first language, and the standard translation text being the text in the second language; determining confidences and matching degrees of the at least one target data-pair, a confidence of the target data-pair indicating reliability of the target data-pair, and a matching degree of the target data-pair indicating similarity of the second text feature in the target data-pair with the first text feature; determining at least one second probability based on the confidences and the matching degrees of the at least one target data-pair, the at least one second probability indicating probabilities that the first text is translated into various standard translation texts in the at least one target data-pair; and determining, based on the at least one first probability and the at least one second probability, a translation text corresponding to the first text.

Embodiments of the present disclosure provide a non-transitory computer-readable storage medium containing at least one computer program that, when being executed, causes a computer to perform: determining at least one first probability based on a first text feature, the first text feature being a text feature of a first text, the first text being a text in a first language, the at least one first probability indicating probabilities that the first text is translated into various candidate texts of at least one candidate text, and the at least one candidate text being a text in a second language; obtaining at least one target data-pair matching the first text feature, a target data-pair comprising one second text feature and one standard translation text of a second text, the second text feature being a text feature of the second text, the second text being the text in the first language, and the standard translation text is the text being the second language; determining confidences and matching degrees of the at least one target data-pair, a confidence of the target data-pair indicating reliability of the target data-pair, and a matching degree of the target data-pair indicating similarity of the second text feature in the target data-pair with the first text feature; determining at least one second probability based on the confidences and the matching degrees of the at least one target data-pair, the at least one second probability indicating probabilities that the first text is translated into various standard translation texts in the at least one target data-pair; and determining, based on the at least one first probability and the at least one second probability, a translation text corresponding to the first text.

### BRIEF DESCRIPTION OF THE DRAWINGS

FIG. 1 is a schematic diagram of an implementation environment according to an embodiment of the present disclosure;

FIG. 2 is a flowchart of a text translation method according to an embodiment of the present disclosure;

FIG. 3 is a schematic diagram of a text translation model based on a confidence according to an embodiment of the present disclosure;

FIG. 4 is a flowchart of a text translation model obtaining method according to an embodiment of the present disclosure;

FIG. 5 is a schematic diagram of constructing a data-pair with noise according to an embodiment of the present disclosure;

FIG. 6 is a schematic diagram of obtaining a sample data-pair according to an embodiment of the present disclosure;

FIG. 7 is a schematic diagram of a text translation apparatus according to an embodiment of the present disclosure;

FIG. 8 is a schematic diagram of a text translation model obtaining apparatus according to an embodiment of the present disclosure;

FIG. 9 is a schematic diagram of a structure of a server according to an embodiment of the present disclosure; and

FIG. 10 is a schematic diagram of a structure of a terminal according to an embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

In some embodiments, a text translation method and a text translation model obtaining method provided in embodiments of the present disclosure may be applied to various scenarios including but not limited to cloud technology, artificial intelligence, intelligent transportation, assisted driving, and the like.

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, artificial intelligence is a comprehensive technology in computer science and attempts to understand essence of intelligence and produce a new intelligent machine that can react in a manner similar to human intelligence. Artificial intelligence is to study design principles and implementation methods of various intelligent machines, to enable the machines to have functions of perception, reasoning, and decision-making.

An artificial intelligence technology is a comprehensive discipline, and relates to a wide range of fields including both hardware-level technologies and software-level technologies. A basic artificial intelligence technology generally includes technologies such as a sensor, a dedicated artificial intelligence chip, cloud computing, distributed storage, a big data processing technology, an operating/interaction system, and electromechanical integration. An artificial intelligence software technology mainly includes several major directions such as a computer vision technology, a speech processing technology, a natural language processing technology, and machine learning/deep learning, autonomous driving, and intelligent transportation.

Natural language processing (NLP) is an important direction in the fields of computer science and artificial intelligence. The natural language processing studies various theories and methods that enable efficient communication between humans and computers in a natural language. The natural language processing is a unified science of linguistics, computer science, and mathematics. As a result, research in this field involves a natural language, namely, a language that people use every day, so the research is closely linked to research on linguistics. A natural language processing technology generally includes technologies of text processing, semantic understanding, machine translation, robotic question answering, knowledge graph, and the like.

Machine learning (ML) is a multi-field inter-discipline, and relates to a plurality of disciplines such as a probability theory, statistics, an approximation theory, convex analysis, and an algorithm complexity theory. The machine learning specializes in studying how a computer simulates or implements a human learning behavior to obtain new knowledge or skills, and reorganize an existing knowledge structure, to keep improving performance of the machine learning. The machine learning is a core of artificial intelligence and a basic way to make a computer intelligent, and is used in various fields of artificial intelligence. The machine learning and deep learning generally include technologies such as an artificial neural network, a belief network, reinforcement learning, transfer learning, inductive learning, and learning from demonstrations.

As the artificial intelligence technology is researched and advanced, the artificial intelligence technology is researched and used in a plurality of fields, such as a common smart home, smart wearing device, virtual assistant, smart sound box, smart marketing, self-driving, autonomous driving, drone, robot, smart medicine, smart customer service, vehicle-to-everything, autonomous driving, intelligent transportation, and the like. It is believed that as the technology develops, the artificial intelligence technology will be used in more fields and exert increasingly important values.

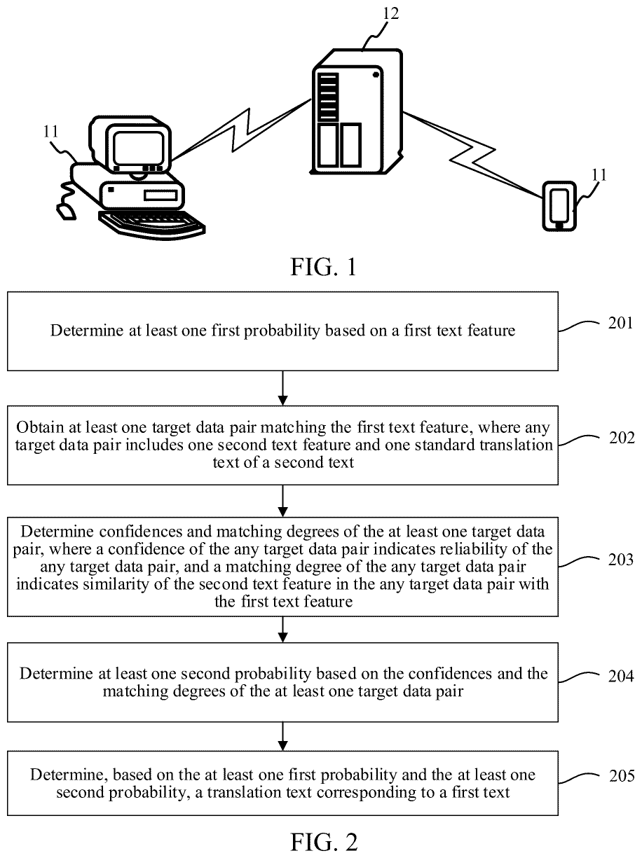

FIG. 1 is a schematic diagram of an implementation environment according to an embodiment of the present disclosure. The implementation environment includes: a terminal 11 and a server 12.

The text translation method provided in this embodiment of the present disclosure may be performed by the terminal 11, may be performed by the server 12, or may be performed by both the terminal 11 and the server 12. This is not limited in this embodiment of the present disclosure. When the text translation method provided in the embodiment of the present disclosure is jointly performed by the terminal 11 and the server 12, the server 12 undertakes primary computation work, and the terminal 11 undertakes secondary computation work. Alternatively, the server 12 undertakes secondary computation work and the terminal 11 undertakes primary computation work. Alternatively, a distributed computation architecture is employed between the server 12 and the terminal 11 for coordinated computation.

The text translation model obtaining method provided in this embodiment of the present disclosure may be performed by the terminal 11, may be performed by the server 12, or may be performed by both the terminal 11 and the server 12. This is not limited in this embodiment of the present disclosure. When the text translation model obtaining method provided in the embodiment of the present disclosure is jointly performed by the terminal 11 and the server 12, the server 12 undertakes primary computation work, and the terminal 11 undertakes secondary computation work. Alternatively, the server 12 undertakes secondary computation work and the terminal 11 undertakes primary computation work. Alternatively, a distributed computation architecture is employed between the server 12 and the terminal 11 for coordinated computation.

An execution device of the text translation method may be the same as or different from an execution device of the text translation model obtaining method. This is not limited in the embodiment of the present disclosure.

In some embodiments, the terminal 11 is any electronic product, such as a personal computer (PC), a cell phone, a smartphone, a personal digital assistant (PDA), a wearable device, a pocket personal computer (PPC), a tablet computer, a smart car, a smart television, a smart sound box, a smart voice interactive device, a smart appliance, an in-vehicle terminal, a virtual reality (VR) device, a augmented reality (AR) device, and the like, that can interact with a user through one or more of a keyboard, a touch pad, a touchscreen, a remote control, a voice interactive or handwriting device. The server 12 may be one server, a server cluster including a plurality of servers, or a cloud computing service center. A communication connection is established between the terminal 11 and the server 12 by using a wireless network or a wired network.

It is appreciated by a person skilled in the art that the terminal 11 and server 12 described above are merely exemplary and if other existing or hereafter possible terminals or servers may be suitable for the present disclosure, the terminals and servers are also within the scope the present disclosure and are incorporated herein by reference.

The methods provided in embodiments of the present disclosure can be used in a number of scenarios.

For example, in an online translation scenario: The server uses the text translation model obtaining method provided in embodiments of the present disclosure, training is performed on an initial text translation model, and a trained target text translation model is deployed in the server. The terminal logs into a translation application based on a user identifier. The server provides services for the translation application. The terminal transmits a first text in a first language to be translated to the server based on the translation application. The server receives the first text, translates into a translation text in a second language of the first text based on the target text translation model by using the text translation method provided in embodiments of the present disclosure, and transmits the translation text to the terminal. The terminal receives and displays the translation text based on the translation application. The first language and the second language are different languages. In some embodiments, the first language may also be referred to as a source language and the second language may also be referred to as a target language.

For another example, in a face-to-face dialog scenario: The server uses the text translation model obtaining method provided in embodiments of the present disclosure, training is performed on an initial text translation model, and a trained target text translation model is deployed in the server. The terminal logs into a translation application based on a user identifier. The server provides services for the translation application. The terminal collects speech data in a first language uttered by any interlocutor based on the translation application, converts the speech data into a first text in the first language, and transmits the first text to be translated to the server based on the translation application. The server receives the first text, translates into a translation text in a second language with the same meaning as the first text based on the target text translation model by using the text translation method provided in embodiments of the present disclosure, and transmits the translation text to the terminal. The terminal receives the translation text based on the translation application, converts the translation text into speech data in the second language, and plays the converted speech data, so that an interlocutor corresponding to the terminal can listen to the played speech data, thereby achieving a simultaneous translation effect, to guarantee a conversation between two interlocutors communicating in different languages.

This embodiment of the present disclosure provides the text translation method applicable to the above-described implementation environment shown in FIG. 1. The text translation method is performed by a computer device. The computer device may be the terminal 11 or the server 12. This is not limited in this embodiment of the present disclosure. As shown in FIG. 2, the text translation method provided in this embodiment of the present disclosure includes the following operation 201 to operation 205.

Operation 201: Determine at least one first probability based on a first text feature.

The first text feature is a text feature of a first text, and the first text is a text to be translated in a first language. A type of the first language is not limited in this embodiment of the present disclosure. For example, the first language may be Chinese, English, or the like. The first text may include one or more characters, and a length of the character included in the first text may be determined empirically or based on actual translation requirements. For example, when the first language is Chinese, the first text may include one Chinese character or may include a plurality of Chinese characters, and the plurality of Chinese characters may constitute a word or a sentence. The at least one first probability indicates probabilities that the first text is translated into various candidate texts in at least one candidate text, in other words, a first probability corresponding to any candidate text indicates a probability that the first text is translated into the any candidate text.

A manner in which a computer device obtains the first text may be that the computer device receives the first text uploaded by a user, that the computer device performs text conversion on a speech in the first language uploaded by the user to obtain the first text, or that the computer device extracts the first text from a web page. This is not limited in the embodiment of the present disclosure.

In some embodiments, the manner in which the computer device obtains the first text may also be that the computer device extracts the first text from a target text. The target text refers to a text that includes the first text. For example, the target text is a sentence to be translated, a process of translating the sentence to be translated is implemented by successively translating each word in the sentence, and the first text is a word currently to be translated in the target text.

After a server obtains the first text, it is needed to perform feature extraction on the first text to obtain the first text feature. Then the server, based on the obtained first text feature, may determine the first probability of each candidate text in a second language. The first text feature represents the first text, and a form of the first text feature is not limited in this embodiment of the present disclosure as long as the first text feature can be easily recognized and processed by the computer device. For example, the form of the first text feature may be a vector, a matrix, or the like.

In some embodiments, a process of performing feature extraction on the first text to obtain the first text feature may be: The first text is encoded to obtain an encoded feature; and the encoded feature is decoded to obtain the first text feature.

When the server determines the first probability of each candidate text based on the first text feature, each candidate text is a text in the second language, and the second language is a language of a translation text to be obtained. The second language is different from the first language, and a type of the second language can be flexibly set based on translation requirements. This is not limited in this embodiment of the present disclosure. For example, when the translation requirement is to translate Chinese to English, the first language is Chinese and the second language is English.

Each candidate text may be set empirically, or flexibly adjusted based on an application scenario. For example, each candidate text may include a text, extracted from an article in the second language, having an occurrence frequency greater than a frequency threshold, or a text extracted from a text library in the second language.

The first probability of the any candidate text refers to a probability that the translation text of the first text is the any candidate text, determined based on the first text feature. For example, the first probability corresponding to the any candidate text is one value from 0 to 1. For example, a sum of the first probability separately corresponding to each candidate text may be 1. For example, the first probability separately corresponding to each candidate text may be represented by using a histogram. A column separately corresponding to each candidate text is included in the histogram, and a height of the column corresponding to the any candidate text indicates the first probability corresponding to the any candidate text.

In some embodiments, operation 201 may be implemented by invoking a target text translation model, in other words, invoking the target text translation model to determine, based on the first text feature, the first probability separately corresponding to each candidate text. The target text translation model is a model for translating the text in the first language into the text in the second language. A structure of the target text translation model is not limited in this embodiment of the present disclosure as long as text translation can be implemented.

In some embodiments, the target text translation model includes a first translation sub-model, a second translation sub-model, and a third translation sub-model. The first translation sub-model is configured to implement feature extraction on a text to be translated and predict, based on an extracted feature, the first probability separately corresponding to each candidate text. The second translation sub-model is configured to retrieve a matched data-pair based on the feature extracted by the first translation sub-model and to determine, based on the retrieved data-pair, a second probability respectively corresponding to a standard translation text in each retrieved data-pair. The third translation sub-model is configured to determine the translation text corresponding to the first text based on the first probability determined by the first translation sub-model and the second probability determined by the first translation sub-model.

When the structure of the target text translation model is the above structure, an implementation process of invoking the target text translation model to determine, based on the first text feature, the first probability separately corresponding to each candidate text refers to: The first translation sub-model is invoked in the target text translation model to determine, based on the first text feature, the first probability separately corresponding to each candidate text. A type of the first translation sub-model is not limited in this embodiment of the present disclosure as long as the first translation sub-model can have feature extraction and probability determining functions. For example, the first translation sub-model may be a neural machine translation (NMT) model, may also be a recurrent neural network (RNN) model, or may also be another model.

An example in which the first translation sub-model is the NMT model is illustrated in the embodiment of the present disclosure. The NMT model uses an encoder-decoder framework, and after input of the first text into the first translation sub-model, an encoder in the first translation sub-model encodes the first text, to obtain the encoded feature. The obtained encoded feature is then input into a decoding layer in a decoder to decode the encoded feature to obtain the first text feature. A prediction layer in the encoder determines, based on the first text feature, the first probability separately corresponding to each text candidate text. In some embodiments, the NMT model may be a model based on a Transformer (transformer) structure.

Operation 202: Obtain at least one target data-pair matching the first text feature. Any target data-pair includes one second text feature and one standard translation text of a second text.

The second text feature is a text feature of the second text, the second text is the text in the first language, and the standard translation text is the text in the second language.

In some embodiments, the server obtains, based on the first text feature, the at least one target data-pair matching the first text feature from a data-pair library. The data-pair library includes at least one data-pair, and any data-pair in the data-pair library includes the second text feature and the standard translation text corresponding to the second text feature. The second text feature is a feature obtained by performing feature extraction on the second text and the standard translation text corresponding to the second text feature is an accurate translation text of the second text.

The target data-pair is a data-pair in the data-pair library that matches the first text feature. A number of target data-pairs that need to be obtained can be set empirically, or flexibly adjusted based on an application scenario. This is not limited in the embodiment of the present disclosure. For example, the number of target data-pairs may be 4, 8, or the like.

In some embodiments, an implementation process of obtaining the at least one target data-pair matching the first text feature from the data-pair library includes: A matching degree of each data-pair in the data-pair library is determined, and a data-pair whose matching degree satisfies a matching condition is used as the at least one target data-pair matching the first text feature. A matching degree of the any data-pair indicates similarity of the second text feature in the any data-pair is to the first text feature. For example, the matching degree of the any data-pair may be positively correlated with the similarity of the second text feature in the any data-pair to the first text feature, and in this case, higher similarity indicates a higher matching degree. Alternatively, the matching degree of the any data-pair may be inversely correlated with the similarity of the second text feature in the any data-pair to the first text feature, and in this case, lower similarity indicates a higher matching degree.

In some embodiments, the matching degree of the any data-pair may be inversely correlated with the similarity of the second text feature in the any data-pair to the first text feature. For example, a distance between the second text feature in the any data-pair and the first text feature is used as the matching degree of the any data-pair. A manner in which the distance between the two text features is calculated is not limited in the embodiment of the present disclosure. For example, an L2 distance (also referred to as a Euclidean distance) between the two text features is calculated, a cosine distance between the two text features is calculated, or an L1 distance (also referred to as a Manhattan distance) between the two text features is calculated.

In some embodiments, the matching degree of the any data-pair may be positively correlated with the similarity of the second text feature in the any data-pair to the first text feature. For example, the similarity of the second text feature in the any data-pair to the first text feature is used as the matching degree of the any data-pair. The similarity indicates the similarity of the second text feature to the first text feature. The manner in which the similarity between the two text features is calculated is not limited in the embodiment of the present disclosure. For example, cosine similarity between the two text features is calculated, Pearson similarity between the two text features is calculated, and the like.

In some embodiments, the data-pair whose matching degree satisfies the matching condition refers to a data-pair whose similarity of the second text feature to the first text feature is high, and that the matching degree satisfies the matching condition can be flexibly adjusted based on the manner of calculating the matching degree. Refer to the following two cases.

Case one: If the matching degree of the any data-pair refers to a distance between the second text feature and the first text feature in the any data-pair, the data-pair whose matching degree satisfies the matching condition may refer to a data-pair whose matching degree is less than a distance threshold, or may refer to a data-pair whose matching degree is the smallest top K (K is an integer not less than 1) matching degrees in all matching degrees, and K is a number of target data-pairs to be needed. The distance threshold is set empirically, or flexibly adjusted based on an application scenario.

Case 2: If the matching degree of the any data-pair refers to the similarity of the second text feature in the any data-pair and the first text feature, the data-pair whose matching degree satisfies the matching condition may refer to a data-pair whose matching degree is greater than a similarity threshold, or may refer to a data-pair whose matching degree is the largest top K (K is an integer not less than 1) matching degrees in all matching degrees. The similarity threshold is set empirically, or flexibly adjusted based on an application scenario.

Before obtaining the at least one target data-pair matching the first text feature from the data-pair library, it is needed that the data-pair library is constructed first. For example, a process of constructing the data-pair library includes: A plurality of second texts are obtained; and feature extraction is separately performed on each second text to obtain a plurality of second text features, and each second text corresponds to one second text feature. The second text feature corresponding to each second text and a standard translation text corresponding to each second text are each constitute one data-pair, thereby implementing that the data-pair includes the second text feature and the standard translation text.

The second text is extracted from a sample text including the second text, and the sample text is the text in the first language. The standard translation text corresponding to the second text can be extracted from a standard translation text corresponding to the sample text. The sample text is a text having the standard translation text, and the standard translation text corresponding to the sample text can be obtained by a professional translating the sample text. The standard translation text is a text in the second language. The standard translation text corresponding to the sample text represents the same semantics by using different languages. For example, one sample text and the standard translation text corresponding to the one sample text may constitute one sample instance, and a plurality of sample instances may constitute a sample set. In some embodiments, a sample instance may also be referred to as a training instance, and a sample set may also be referred to as a training set.

In some embodiments, a process of extracting the second text feature of the second text may be implemented by invoking a text feature extraction model. A type of the text feature extraction model is not limited in this embodiment of the present disclosure. For example, the text feature extraction model may refer to a part of models in the NMT model for extracting the text feature. The method for extracting the second text feature has the same principle as the method for extracting the first text feature in operation 201. Details are not described herein again.

In a process of constructing the data-pair library, feature extraction is performed on the second text in all sample instances in the sample set by using the text feature extraction model (for example, a part of models in the NMT model for extracting a text feature) to obtain the plurality of second text features. The second text feature and the standard translation text corresponding to the second text feature are recorded and stored as a data-pair in the data-pair library. For example, the second text feature may also be referred to as decoder-generated representation corresponding to the second text, and the standard translation text corresponding to the second text feature may also be referred to as a correct translation text corresponding to the second text feature.

In some embodiments, the second text feature in each data-pair may be used as a key (key) and the standard translation text in each data-pair as a value, and each data-pair may be represented as one key-value pair.

In some embodiments, a sample set {(x, y)} is given, where (x, y) represents one sample instance, x represents a sample text, and y represents a standard translation text corresponding to the sample text. A data-pair library D may be constructed in a manner according to the following Formula (1):

$$D = \{ ( {h}_{t} , {y}_{t} ) , ∀ {y}_{t} ∈ y \vert ( x , y ) \} \qquad Formula ( 1 )$$

(hₜ, yₜ) represents one data-pair; hₜ represents a key of the data-pair, i.e., a second text feature corresponding toyₜ; and yₜ represents a value of the data-pair, namely, a standard translation text corresponding to the second text feature. yₜ can be seen as a correct translation text corresponding to a standard translation text y at a moment t in the sample instance (x, y). A well-constructed data-pair library stores useful assistance information of the NMT model on the sample set, and the information can be configured for assistance prediction in a text translation phase.

In some embodiments, an example is used in which a number of at least one target data-pair is K, and K is an integer not less than 1. A k^{th} data-pair (k is any integer from 1 to K) in the K target data-pairs may be represented as (hₖ, vₖ), where hₖ represents a second text feature in the k^{th} data-pair; vₖ represents a standard translation text in the k^{th} data-pair.

In some embodiments, operation 202 may be implemented by invoking the target text translation model, to be specific, invoking the target text translation model to obtain the at least one target data-pair matching the first text feature. For example, an example is used in which a structure of the target text translation model is the structure introduced in operation 201, and invoking the target text translation model to obtain the at least one target data-pair matching the first text feature may refer to: The second translation sub-model in the target text translation model is invoked to obtain the at least one target data-pair matching the first text feature. For example, the second translation sub-model includes a data-pair retrieval network for retrieving a matched data-pair from the data-pair library, and a process of obtaining the at least one target data-pair matching the first text feature may be implemented through the data-pair retrieval network in the second translation sub-model. For example, the data-pair retrieval network may be a simple feed-forward neural network, or another more complex network.

Operation 203: Determine confidences and matching degrees of the at least one target data-pair. A confidence of the any target data-pair indicates reliability of the any target data-pair, and a matching degree of the any target data-pair indicates similarity of the second text feature in the any target data-pair with the first text feature.

A method of determining the matching degree of the at least one target data-pair is described in operation 202. Details are not described herein again. In a method provided in this embodiment of the present disclosure, after obtaining the at least one target data-pair matching the first text feature, the confidences of the at least one target data-pair needs to be separately determined, and a confidence of the any target data-pair indicates the reliability of the any target data-pair. In some embodiments, the confidence of the any target data-pair is positively correlated with the reliability of the any target data-pair, to be specific, a greater confidence of the any target data-pair, indicates greater reliability of the any target data-pair. By considering the confidences of the at least one target data-pair, the determined second probability can be more reliable and, to further enable high accuracy of the translation text corresponding to the first text.

In some embodiments, operation 203 may be implemented by invoking the target text translation model, to be specific, the target text translation model is invoked to determine the confidences of the at least one target data-pair. In some embodiments, an example is used in which the structure of the target text translation model is the structure introduced in operation 201, and that the target text translation model is invoked to determine the confidences of the at least one target data-pair may refer to: The second translation sub-model in the target text translation model is invoked to determine the confidences of the at least one target data-pair. In some embodiments, the second translation sub-model includes, in addition to the data-pair retrieval network involved in operation 202, a probability distribution prediction network, and a process of determining the confidences of the at least one target data-pair may be implemented by the probability distribution prediction network in the second translation sub-model.

A principle of determining the confidence of each of the at least one target data-pair is the same, and in the embodiment of the present disclosure, a process of determining the confidence of the any target data-pair is used as an example. In some embodiments, an implementation process of determining the confidence of the any target data-pair includes: Based on the second text feature in the any target data-pair, at least one third probability is determined, namely, a third probability separately corresponding to each candidate text. The at least one third probability indicates a probability that the second text in the any target data-pair is translated into each candidate text, in other words, the third probability corresponding to the any candidate text indicates a probability that the second text corresponding to the any target data-pair is translated into the any candidate text. A fourth probability is determined based on the at least one third probability. The fourth probability indicates a probability that the second text corresponding to the any target data-pair is translated into the standard translation text in the any target data-pair. Based on the fourth probability, the confidence of the any target data-pair is determined.

A principle of determining the third probability separately corresponding to each candidate text based on the second text feature is the same as a principle of determining the first probability separately corresponding to each candidate text based on the first text feature. Details are not described herein again. A probability that the second text corresponding to the any target data-pair is translated into the any candidate text is referred to as the third probability. Based on the third probability separately corresponding to each candidate text, a probability that the second text is translated into the standard translation text in the any target data-pair is determined is a fourth probability.

In some embodiments, a process of determining a probability that the second text is translated into the standard translation text in the any target data-pair based on the third probability separately corresponding to each candidate text, that is, a process of determining the fourth probability based on the at least one third probability includes: If the third probability separately corresponding to each candidate text includes the third probability corresponding to the standard translation text in the any target data-pair, the standard translation text is one of each candidate text. In this case, the third probability corresponding to the standard translation text in the any target data-pair is used as the fourth probability, namely, a probability that the second text is translated into the standard translation text in the any target data-pair. If the third probability corresponding to each candidate text does not include the third probability corresponding to the standard translation text in the any target data-pair, the standard translation text in the any target data-pair is not one of each candidate text. In this case, a first value can be used as the fourth probability, namely, a probability that the second text is translated into the standard translation text in the any target data-pair. The first value is a value not greater than a minimum value in the third probability separately corresponding to each candidate text, for example, each third probability is in a range of 0 to 1, and then the first value may be 0. An example is used in which the standard translation text in the any target data-pair is one of each candidate text. A greater probability that the second text is translated into the standard translation text in the any target data-pair indicates a greater probability that the standard translation text is obtained through prediction based on the second text feature, that is, the reliability of the any target data-pair is greater.

In some embodiments, a process of determining the confidence of the any target data-pair based on a probability that the second text is translated into the standard translation text in the any target data-pair, namely, the fourth probability, includes: The probability that the second text is translated into the standard translation text in the any target data-pair is converted, that is, the fourth probability is converted. A value after the conversion is used as the confidence of the any target data-pair. An example is used in which the confidences of the at least one target data-pair is determined by the probability distribution prediction network in the second translation sub-model. The probability that the second text is translated into the standard translation text in the any target data-pair, namely, the fourth probability, is input into the probability distribution prediction network. The fourth probability is converted by the probability distribution prediction network, and a value output by the probability distribution prediction network is used as the confidence of the any target data-pair. A process of the probability distribution prediction network converting the probability that the second text is translated into the standard translation text in the any target data-pair is an internal calculation process of the probability distribution prediction network. This is not limited in the embodiment of the present disclosure as long as it is ensured that the output confidence is positively correlated with the probability that the second text is translated into the standard translation text in the any target data-pair.

In some embodiments, a process of the probability distribution prediction network converting the fourth probability determined based on a k^{th} (k is any integer from 1 to K) target data-pair (hₖ, vₖ) may be represented according to Formula (2):

$${c}_{k} = {W}_{3} ( tanh ( {W}_{4} [ {p}_{NMT} ( {v}_{k} \vert {h}_{k} ) ] ) ) \qquad Formula ( 2 )$$

cₖ represents a value output by the probability distribution prediction network, namely, the confidence of a k^{th} target data-pair. W₃ and W₄ a network parameter of the probability distribution prediction network, and the network parameter is a trainable parameter. p_{NMT}(vₖ|hₖ) represents a probability that a second text corresponding to the k^{th} target data-pair is translated into a standard translation text in any target data-pair, namely, a fourth probability determined based on the k^{th} target data-pair. hₖ represents a second text feature in the k^{th} target data-pair. vₖ represents the standard translation text in the k^{th} target data-pair. NMT represents the NMT model with which a third probability is predicted.

In some embodiments, an implementation process of determining the confidence of the any target data-pair based on the probability that the second text is translated into the standard translation text in the any target data-pair, namely, the fourth probability, includes: A fifth probability is determined based on the first probability, namely, at least one first probability, separately corresponding to each candidate text. The fifth probability indicates a probability that the first text is translated into the standard translation text in the any target data-pair. Based on the probability that the second text is translated into the standard translation text in the any the target data-pair and the probability that the first text is translated into the standard translation text in the any target data-pair, the confidence of the any target data-pair is determined, that is, the confidence of the any target data-pair is determined based on the fourth probability and the fifth probability.

In some embodiments, an implementation process of determining a probability that the first text is translated into the standard translation text in the any target data-pair based on the first probability separately corresponding to each candidate text, namely, a process of determining the fifth probability based on the at least one first probability includes: If the first probability separately corresponding to each candidate text includes the first probability corresponding to the standard translation text in the any target data-pair, the standard translation text in the any target data-pair is one of each candidate text. In this case, the first probability corresponding to the standard translation text in the any target data-pair is used as the fifth probability, namely, the probability that the first text is translated into the standard translation text in the any target data-pair. If the first probability separately corresponding to each candidate text does not include the first probability corresponding to the standard translation text in the any target data-pair, the standard translation text in the any target data-pair is not one of each candidate text. In this case, a second value may be used as the probability that the first text is translated into the standard translation text in the any target data-pair. The second value is a value not greater than a minimum value in the first probability separately corresponding to each candidate text, for example, each first probability is in a range of 0 to 1, and then the second value may be 0. An example is used in which the standard translation text in the any target data-pair is one of each candidate text. A greater probability that the first text is translated into the standard translation text in the any target data-pair indicates that a greater probability that the standard translation text is obtained through prediction based on the first text feature. Due to great similarity of the first text feature to the second text feature in the any target data-pair, a greater probability that the standard translation text in the any target data-pair is obtained through prediction based on the first text feature may indicate, to some extent, a greater probability that the standard translation text in the any target data-pair is obtained through prediction based on the second text feature in the any target data-pair, that is, the reliability of the any target data-pair is greater.

In some embodiments, based on the probability that the second text is translated into the standard translation text in the any the target data-pair and the probability that the first text is translated into the standard translation text in the any target data-pair, an implementation process of determining the confidence of the any target data-pair, that is, an implementation process of determining the confidence of the any target data-pair based on the fourth probability and the fifth probability is: The probability that the second text is translated into the standard translation text in the any target data-pair and the probability that the first text is translated into the standard translation text in the any target data-pair are input into the probability distribution prediction network, the probability that the second text is translated into the standard translation text in the any target data-pair and the probability that the first text is translated into the standard translation text in the any target data-pair are converted by the probability distribution prediction network, and a value output by the probability distribution prediction network is used as the confidence of the any target data-pair. That is, the fourth probability and the fifth probability are input into the probability distribution prediction network, the fourth probability and the fifth probability are converted by the probability distribution prediction network, and the value output by the probability distribution prediction network is used as the confidence of the any target data-pair. The process of the probability distribution prediction network converting the fourth probability and the fifth probability is an internal calculation process of the probability distribution prediction network. This is not limited in the embodiment of the present disclosure as long as it is ensured that the output confidence is positively correlated with the fourth probability and the fifth probability.

In some embodiments, the confidence of the at least one target data-pair may be determined according to the following Formula (3):

$${c}_{k} = {W}_{3} ( tanh ( {W}_{4} [ {p}_{NMT} ( {v}_{k} \vert ) ; {p}_{NMT} ( {v}_{k} \vert {h}_{k} ) ] ) ) \qquad Formula ( 3 )$$

cₖ is a confidence of a k^{th} target data-pair, greater cₖ represents the more important k^{th} target data-pair. vₖ is a standard translation text in the k^{th} target data-pair. hₖ is a second text feature in the k^{th} target data-pair. [symbol] is a first text feature. p_{NMT}(vₖ| [symbol] ) is a probability that a first text is translated into the standard translation text in the k^{th} target data-pair, namely, a fifth probability. p_{NMT}(vₖ|hₖ) is a probability that the second text corresponding to the k^{th} target data-pair is translated into the standard translation text in the k^{th} target data-pair, namely, a fourth probability. W₃ and W₄ a network parameter of the probability distribution prediction network, and the network parameter is a trainable parameter. cₖ is positively correlated with p_{NMT}(vₖ| [symbol] ) and p_{NMT}(vₖ|hₖ), separately.

In some embodiments, a manner in which the confidence of the any target data-pair is determined further may be: A probability is determined that the first text is translated into the standard translation text in the any target data-pair based on the first probability separately corresponding to each candidate text; and the probability is converted that the first text is translated into the standard translation text in the any target data-pair, and a converted value is used as the confidence of the any target data-pair. That is, based on the at least one first probability, the fifth probability is determined, where the fifth probability indicates a probability that the first text is translated into the standard translation text in the any target data-pair. The fifth probability is converted and a converted value is used as the confidence of the any target data-pair.

In some embodiments, an example is used in which the confidence of the at least one target data-pair is determined by the probability distribution prediction network in the second translation sub-model. The probability that the text is translated into the standard translation text in the any target data-pair is input into the probability distribution prediction network, the probability that the first text is translated into the standard translation text in the any target data-pair is converted by the probability distribution prediction network, and the value output by the probability distribution prediction network is used as the confidence of the any target data-pair. That is, the fifth probability is input into the probability distribution prediction network, the fifth probability is converted by the probability distribution prediction network, and the value output by the probability distribution prediction network is used as the confidence of the any target data-pair. A process of the probability distribution prediction network converting the probability that the first text is translated into the standard translation text in the any target data-pair is an internal calculation process of the probability distribution prediction network. This is not limited in the embodiment of the present disclosure as long as it is ensured that an output confidence is positively correlated with the probability that the first text is translated into the standard translation text in the any target data-pair.

For example, a process of the probability distribution prediction network converting a fifth probability determined based on a k^{th} (k is any integer from 1 to K) target data-pair (hₖ, vₖ) may be represented according to Formula (4):

$${c}_{k} = {W}_{3} ( tanh ( {W}_{4} [ {p}_{NMT} ( {v}_{k} \vert ) ] ) ) \qquad Formula ( 4 )$$

cₖ represents a value output by the probability distribution prediction network, namely, a confidence of the k^{th} target data-pair. W₃ and W₄ a network parameter of the probability distribution prediction network, and the network parameter is a trainable parameter. p_{NMT}(vₖ| [symbol] ) represents that a probability that a first text is translated into a standard translation text in any target data-pair, namely, the fifth probability. [symbol] represents a first text feature. vₖ represents a standard translation text in the k^{th} target data-pair. NMT represents the NMT model with which the first probability is predicted.

Operation 204: Determine at least one second probability based on the confidences and the matching degrees of the at least one target data-pair.

The at least one second probability indicates probabilities that the first text is translated into various standard translation texts in the at least one target data-pair, and a second probability corresponding to any standard translation text indicates a probability that the first text is translated into the any standard translation text. Each standard translation text is to be a non-duplicated translation text, for example, two of ten target data-pairs retrieved have the same standard translation text. In this case, a number of standard translation texts is nine. In calculating the second probability separately corresponding to each standard translation text, probabilities separately corresponding to the same standard translation texts need only be summed.

In some embodiments, operation 204 can be implemented by invoking the target text translation model, that is, by the target text translation model, based on the confidence and the matching degree of the at least one target data-pair, the second probability separately corresponding to each standard translation text in the at least one target data-pair is determined. An example is used in which the structure of the target text translation model is the structure introduced in operation 201, and invoking the target text translation model to determine the confidence of the at least one target data-pair may refer to: The second translation sub-model in the target text translation model is invoked to determine the confidence of the at least one target data-pair. For example, the second translation sub-model includes, in addition to the data-pair retrieval network involved in operation 202, the probability distribution prediction network, and a process of determining the second probability separately corresponding to each standard translation text of the at least one target data-pair may be implemented by the probability distribution prediction network in the second translation sub-model. For example, due to the process of determining the second probability considering not only the matching degree but additionally the confidence, the probability distribution prediction network can be regarded as a distribution calibration (DC) network relative to a network that determines the second probability by considering only the matching degree.

In some embodiments, based on the confidence and the matching degree of the at least one target data-pair, that the second probability separately corresponding to each standard translation text in the at least one target data-pair is determined includes: The matching degree of the first data-pair for any one of the various standard translation texts is normalized to obtain a normalized matching degree, and the first data-pair is a data-pair including the any standard translation text in the at least one target data-pair; the normalized matching degree is calibrated by using the confidence of the first data-pair to obtain a calibrated matching degree; and a probability that positively correlates with the calibrated matching degree is used as the second probability corresponding to the any standard translation text, to be specific, the second probability corresponding to the any standard translation text is determined based on the calibrated matching degree that positively correlates with the second probability.

The first data-pair is a data-pair including the any standard translation text in the at least one target data-pair, and the first data-pair may be one or more. Each first data-pair has a matching degree and a confidence. That the matching degree of the first data-pair is normalized to obtain a normalized matching degree refers to: The matching degree of each first data-pair is separately normalized to obtain a normalized matching degree separately corresponding to each first data-pair. That the normalized matching degree is calibrated by using the confidence of the first data-pair to obtain a calibrated matching degree refers to: The normalized matching degree separately corresponding to each first data-pair is calibrated by using the confidence of each first data-pair to obtain a calibrated matching degree separately corresponding to each first data-pair.

After the matching degree of the first data-pair is obtained, the matching degree is normalized, and the normalized matching degree can be obtained, thereby improving normalization of the matching degree of the first data-pair. One first data-pair is used as an example. In some embodiments, a manner in which the matching degree of the first data-pair is normalized may be: A hyperparameter is used to normalize the matching degree of the first data-pair. A size of the hyperparameter is also determined before the hyperparameter is used to normalize the matching degree of the first data-pair. A value of the hyperparameter may be set empirically, or flexibly adjusted based on the target data-pair. This is not limited in the embodiment of the present disclosure.

The embodiment of the present disclosure explores that the hyperparameter is dynamically determined based on the target data-pair as an example, and a process of determining the hyperparameter includes: The hyperparameter is determined based on at least one of number indicators of various target data-pairs and the matching degrees of various target data-pairs. The number indicator of the any target data-pair is a number of standard translation texts of various target data-pairs whose arrangement positions are not behind the any target data-pair after various target data-pairs are arranged in a reference order.

In this embodiment of the present disclosure, determining the hyperparameter involves either of two types of data, and the two types of data is: the number indicators of various target data-pairs and the matching degrees of the various target data-pairs. The number indicator of the any target data-pair is a number of standard translation texts of various target data-pairs whose arrangement positions are not offset from the any target data-pair after the various target data-pairs are arranged in a reference order The reference order is set empirically, or flexibly adjusted based on an application scenario, for example, different target data-pairs have different numbers, the reference order may refer to an order in which the numbers are in ascending order, or an order in which the numbers are in descending order. After various target data-pairs are arranged based on reference data, the various target data-pairs have a respective arrangement position, and a number of non-duplicated standard translation texts in the various target data-pairs that are not behind an arrangement position of the any target data-pair is used as a number indicator of the any target data-pairs.

For example, if a number of retrieved target data-pairs is three, respectively a data-pair 1, a data-pair 2, and a data-pair 3, a standard translation text in the data-pair 1 and the data-pair 2 is M1, and a standard translation text in the data-pair 3 is M2. Assuming that the data-pair 1, the data-pair 2, and the data-pair 3 are sequentially located at an arrangement position from front to back after arrangement in the reference order, a number indicator of the data-pair 1 is 1, a number indicator of the data-pair 2 is 2, and a number indicator of the data-pair 3 is 2.

The hyperparameter may be determined based on only the number indicators of various target data-pairs, based on only the matching degrees of the various target data-pair, or based on the number indicators of the various target data-pairs and the matching degrees of the various target data-pair. A value of the hyperparameter can be obtained by inputting at least one of the number indicators of the various target data-pairs and the matching degrees of the various target data-pairs into the probability distribution prediction network for calculation.

An example is used in which the hyperparameter is determined based on the number indicators of the various target data-pairs and the matching degrees of the various target data-pairs, and the hyperparameter may be calculated according to the following Formula (5):

$$T = {W}_{1} ( tanh ( {W}_{2} [ {d}_{1} , … , {d}_{K} ; {r}_{1} , … , {r}_{K} ] ) ) \qquad Formula ( 5 )$$

T is a hyperparameter. W₁ and W₂ are network parameters of the probability distribution prediction network, and the network parameters are trainable parameters. dₖ is a distance between a second text feature and a first text feature in a k^{th} (k is any integer value of 1 to K) target data-pair, namely, a matching degree of the k^{th} target data-pair. tanh ( ) is a hyperbolic tangent function. rₖ is a number indicator of the k^{th} target data-pair. A value of a hyperparameter T can be obtained through calculation by separately putting dₖ and rₖ into Formula (5).

In some embodiments, a manner in which the hyperparameter is used to normalize the matching degree of the first data-pair may be using a ratio of the matching degree of the first data-pair to the hyperparameter as the normalized matching degree, a product of the matching degree of the first data-pair and the hyperparameter as the normalized matching degree, or the like. This is not limited in the embodiment of the present disclosure.

After the normalized matching degree corresponding to the first data-pair is obtained, the normalized matching degree is calibrated by using the confidence of the first data-pair to obtain a calibrated matching degree that matches reliability of the first data-pair. For example, the manner in which the normalized matching degree is calibrated by using the confidence of the first data-pair may be correlated with details of the matching degree of the first data-pair. For example, if the matching degree of the first data-pair is positively correlated with similarity of the first text feature to the second text feature in the first data-pair, a sum of the confidence of the first data-pair and the normalized matching degree may be used as the calibrated matching degree. If the matching degree of the first data-pair is inversely correlated with t similarity of the first text feature to the second text feature in the first data-pair, then a difference between the confidence of the first data-pair and the normalized matching degree may be used as the calibrated matching degree.

In some embodiments, if the first data-pair is one, a probability that the one first data-pair is positively correlated with the calibrated matching degree determined is directly used as the second probability corresponding to the any standard translation text. If the first data-pair is plural, a sum of calibrated matching degrees determined based on a plurality of first data-pairs is calculated, and then a probability of having a positive correlation with a calculated sum of matching degrees is used as the second probability corresponding to the any standard translation text.

For example, an example is used in which the any standard translation text is vₖ. The second probability corresponding to the any standard translation text may be calculated according to the following Formula (6):

$${p}_{kNN} ( {y}_{t} \vert ) ∝ {\sum }_{( {h}_{k} , {v}_{k} ) ∈ {N}_{t}} {1}_{{y}_{t} = {v}_{k}} exp ( \frac{- {d}_{k}}{T} + {c}_{k} ) \qquad Formula ( 6 )$$

p_{kNN}(yₜ| [symbol] ) is a probability of yₜ obtained through prediction based on a first text feature [symbol] . When a second probability corresponding to a standard translation text vₖ is calculated, yₜ=vₖ, to be specific, p_{kNN}(yₜ| [symbol] ) represents a second probability corresponding to the standard translation text vₖ. (hₖ, vₖ) represents one first data-pair. hₖ is a second text feature in the one first data-pair, and vₖ is the standard translation text in the one first data-pair. Nₜ represents a set constituted by various target data-pairs. dₖ represents a matching degree of the one first data-pair. T represents a hyperparameter. cₖ represents a confidence of the first data-pair.

$$\frac{{d}_{k}}{T}$$

represents a normalized matching degree determined based on the one first data-pair.

$$\frac{- {d}_{k}}{T} + {c}_{k}$$

represents a calibrated matching degree determined based on the one first data-pair.

With reference to a manner in which the second probability corresponding to the any standard translation text is obtained, the second probability separately corresponding to each standard translation text can be determined.

An order of determining the first probability separately corresponding to each candidate text and determining the second probability separately corresponding to each standard translation text is not limited in the embodiment of the present disclosure, and can be flexibly set based on actual requirements. After the first probability separately corresponding to each candidate text and the second probability separately corresponding to each standard translation text are determined, operation 205 is performed.

Operation 205: Determine, based on the at least one first probability and the at least one second probability, a translation text corresponding to the first text.

The at least one first probability is the first probability separately corresponding to each candidate text, and the at least one second probability is the second probability separately corresponding to each standard translation text. Accordingly, operation 205 may also be represented as: The translation text corresponding to the first text is determined based on the first probability separately corresponding to each candidate text and the second probability separately corresponding to each standard translation text.

The translation text corresponding to the first text refers to a translation result in the second language corresponding to the first text. The translation text corresponding to the first text is determined by comprehensively considering the first probability separately corresponding to each candidate text and the second probability separately corresponding to each standard translation text. In a process of determining the translation text corresponding to the first text, rich information is considered, and it is advantageous to ensure reliability of the translation text corresponding to the first text. In addition, the second probability separately corresponding to each standard translation text is determined by comprehensively considering the matching degree and the confidence of the target data-pair, rich information is considered, the determined second probability matches reliability of the target data-pair, and reliability of the second probability is high, so that it is advantageous to further improve reliability of the translation text corresponding to the first text.

In some embodiments, a process of determining the translation text corresponding to the first text based on the first probability separately corresponding to each candidate text and the second probability separately corresponding to each standard translation text includes: A first probability distribution is determined based on the first probability separately corresponding to each candidate text; a second probability distribution is determined based on the second probability separately corresponding to each standard translation text; the first probability distribution and the second probability distribution are fused to obtain a fused probability distribution, the fused probability distribution includes a translation probability separately corresponding to each target text, and each target text includes each candidate text and each standard translation text; and a target text with a maximum translation probability in the various target texts is used as the translation text. That is, the first probability distribution is determined based on the at least one first probability; the second probability distribution is determined based on the at least one second probability; the first probability distribution and the second probability distribution are fused to obtain the fused probability distribution, the fused probability distribution includes a translation probability of each target text, and each target text includes each candidate text and each standard translation text; and the target text with a maximum translation probability in the various target texts is used as the translation text.

The first probability distribution includes the first probability separately corresponding to each candidate text, and the second probability distribution includes the second probability separately corresponding to each standard translation text. The manner in which the obtained first probability distribution and the second probability distribution are fused is not limited in the embodiment of the present disclosure as long as the fused probability distribution including the translation probability separately corresponding to each target text can be obtained. Each target text includes each candidate text and each standard translation text, that is, each target text is a text that is not duplicated in each candidate text and each standard translation text. For example, the first probability distribution and the second probability distribution may be fused by using an interpolation weight to obtain the translation text corresponding to the first text.

In some embodiments, that the first probability distribution and the second probability distribution are fused to obtain a fused probability distribution includes: A first importance degree and a second importance degree are determined, where the first importance degree indicates an importance degree of the first probability distribution in a process of obtaining the translation text, the second importance degree indicates an importance degree of the second probability distribution in a process of obtaining the translation text; a target parameter is determined based on the first importance degree and the second importance degree, and the target parameter may also be referred to as a normalized parameter; the first importance degree is converted based on the target parameter to obtain a first weight; the second importance degree is converted based on the target parameter to obtain a second weight; and the first probability distribution and the second probability distribution are fused based on the first weight of the first probability distribution and the first weight of the second probability distribution, to obtain the fused probability distribution.

In some embodiments, operation 205 may be implemented by invoking the target text translation model, to be specific, the translation text corresponding to the first text is determined by the target text translation model based on the first probability to separately corresponding to each candidate text and the second probability separately corresponding to each standard translation text. That is, the translation text corresponding to the first text is determined by the target text translation model based on the at least one first probability and the at least one second probability. An example is used in which a structure of the target text translation model is the structure introduced in operation 201, and operation 205 may be implemented by invoking the third translation sub-model in the target text translation model. For example, the third translation sub-model may include a weight prediction (WP) network for predicting the first weight and the second weight, and a fusion network for fusing the first probability distribution and the second probability distribution based on the first weight and the second weight.

In some embodiments, the first importance degree is obtained through calculation by the weight prediction network based on at least one of a probability that each standard translation text is obtained through the prediction based on the first text feature, a probability that each standard translation text in various target data-pairs is obtained through prediction based on the second text feature in the various target data-pairs, and the first probability separately corresponding to each candidate text. That is, the first importance degree is obtained through calculation by the weight prediction network based on at least one of the at least one fifth probability, the at least one fourth probability, and the at least one first probability.

In some embodiments, an example is used in which the first importance degree is obtained through calculation by the weight prediction network based on the probability that each standard translation text is obtained through prediction based on the first text feature, the probability that the standard translation text in various target data-pairs is obtained through prediction based on the second text feature in the various target data-pairs, and the first probability separately corresponding to each candidate text, and the first importance degree may be calculated according to the following Formula (7):

$${s}_{NMT} = {W}_{5} [ {p}_{NMT} ( {v}_{1} \vert ) , … , {p}_{NMT} ( {v}_{K} \vert ) ; \\ {p}_{NMT} ( {v}_{1} \vert {h}_{1} ) , … , {p}_{NMT} ( {v}_{K} \vert {h}_{K} ) ; {p}_{NMT}^{top 1} , … , {p}_{NMT}^{topK} ] \qquad Formula ( 7 )$$

s_{NMT} represents a first importance degree. p_{NMT}(vₖ| [symbol] ) is a probability that a k^{th} standard translation text is obtained through prediction based on a first text feature, namely, a fifth probability. p_{NMT}(vₖ|hₖ) is a probability, namely, a fourth probability, that a standard translation text in a k^{th} target data-pair is obtained through prediction based on a second text feature of in the k^{th} target data-pair. p_{NMT}^{topk} is a k^{th} greatest probability in a first probability separately corresponding to each candidate text. W₅ is a network parameter of the weight prediction network, and the network parameter is a trainable parameter.

In some embodiments, the second importance degree is determined by the weight prediction network based on at least one piece of information of the number indicators of various target data-pairs and the matching degrees of the various target data-pairs. In some embodiments, an example is used in which the second importance degree is determined by the weight prediction network based on the number indicators of various target data-pairs and the matching degrees of the various target data-pairs, and the second importance degree may be calculated according to the following Formula (8):

$${s}_{kNN} = {W}_{6} ( tanh ( {W}_{7} [ {d}_{1} , … , {d}_{K} ; {r}_{1} , … , {r}_{K} ] ) ) \qquad Formula ( 8 )$$

s_{kNN} is a second importance degree. W₆, W₇ is a network parameter of the weight prediction network, and the network parameter is a trainable parameter. dₖ is a matching degree of a k^{th} target data-pair. rₖ is a number indicator of the k^{th} target data-pair.

After the first importance degree and the second importance degree are obtained through calculation, a normalized parameter is determined based on the first importance degree and the second importance degree. The normalized parameter is a parameter based on which the first importance degree and the second importance degree are converted, and a sum of the first weight and the second weight obtained by converting the first importance degree and the second importance degree based on the normalized parameter is 1. In some embodiments, the second weight is calculated according to the following Formula (9):

$${λ}_{t} = \frac{exp ( {s}_{kNN} )}{exp ( {s}_{kNN} ) + exp ( {s}_{NMT} )} \qquad Formula ( 9 )$$

λₜ represents a second weight. s_{kNN} represents a second importance degree. s_{NMT} represents a first importance degree. exp(s_{kNN})+exp(s_{NMT}) represents a normalized parameter, namely, a target parameter. A process of determining a weight is considered to be a process of dynamically estimating the weight by using a lightweight WP network.

In some embodiments, the sum of the first importance degree and the second importance degree may be used as the target parameter. A ratio of the first importance degree to the target parameter is used as the first weight, and a ratio of the second importance degree to the target parameter is used as the second weight.

In some embodiments, based on the first weight and the second weight, the fused probability distribution may be obtained through calculation according to the following Formula (10):

$$p ( {y}_{t} \vert x , {y}_{< t} ) = {λ}_{t} {p}_{kNN} + ( 1 - {λ}_{t} ) {p}_{NMT} \qquad Formula ( 10 )$$

λₜ is a second weight. p_{kNN} is a second probability distribution; (1−λₜ) is a first weight. p_{NMT} is a first probability distribution. p(yₜ|x, y_{<t}) is a fused probability distribution.

In some embodiments, the fused probability distribution obtained according to Formula (10) above includes a translation probability separately corresponding to a plurality of target texts. A text with a maximum translation probability is determined in the plurality of target texts, and the text is used as the translation text corresponding to the first text.

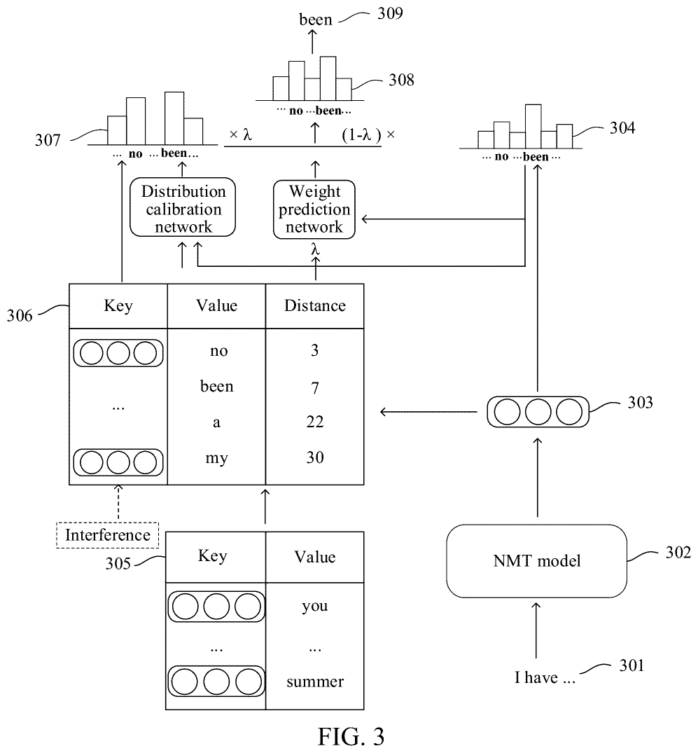

FIG. 3 is a schematic diagram of a text translation model based on a confidence. In FIG. 3, an NMT translation model is used as an example, and a translation process of the model from an input first text to a translation text corresponding to an output first text is described. The schematic diagram includes a process of operation 201 to operation 205 described above. In FIG. 3, 301 is the first text to be translated input into the model, and the first text is a Chinese text. 302 is the NMT translation model. 303 is a first text feature. 304 is a first probability distribution. 305 is a data-pair library. 306 is at least one target data-pair retrieved based on the first text feature. 307 is a second probability distribution. 308 is a fused probability distribution obtained by fusing the first probability distribution and the second probability distribution. 309 is an output translation text corresponding to the first text.

In a technical solution provided in an embodiment of the present disclosure, in a process of determining a second probability, a confidence of the target data-pair is considered in addition to a matching degree of a second text feature in the target data-pair with the first text feature. Rich information is considered. Additionally, the confidence of the target data-pair is used to measure reliability of the target data-pair, and by considering the confidence of the target data-pair, reliability of the second probability can be improved, thereby improving accuracy of text translation.

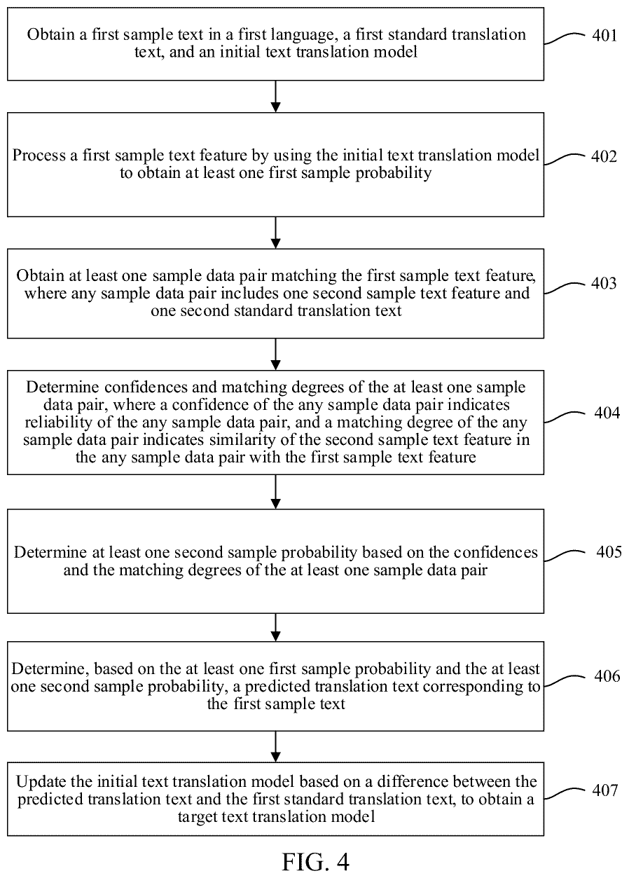

This embodiment of the present disclosure provides a text translation model obtaining method applicable to the above-described implementation environment shown in FIG. 1. The text translation model obtaining method is performed by a computer device. The computer device may be a terminal 11 or a server 12. This is not limited in this embodiment of the present disclosure. As shown in FIG. 4, a text translation model obtaining method provided in an embodiment of the present disclosure includes the following operation 401 to operation 407.

Operation 401: Obtain a first sample text in a first language, a first standard translation text, and an initial text translation model.

The first sample text is the text in the first language and the first standard translation text is the text in a second language obtained by translating the first sample text.

In some embodiments, when a translation requirement is translation of Chinese to English, the first language is Chinese and the second language is English. The first sample text is a text having standard translation, and in this embodiment of the present disclosure, the first standard translation text is a standard translation text of the first sample text. The standard translation text corresponding to the first sample text is in the same language as a language in a translation text that needs to be output by using the initial text translation model to provide supervisory information for a training process of the initial text translation model by using the standard translation text corresponding to the first sample text. Since the first sample text corresponds to the standard translation text, a process of training the initial text translation model by using the first sample text is a supervised training process.

In addition, the first sample text is a text on which a text translation model is trained once. A number of first sample texts may be one or more. This is not limited in this embodiment of the present disclosure. An example is used in which the number of the first sample texts is one for description in the embodiment of the present disclosure. A manner in which the first sample text is obtained can refer to a relevant process in operation 201 in the embodiment shown in FIG. 2. Details are not described herein again.

Operation 402: Process a first sample text feature by using the initial text translation model to obtain at least one first sample probability.

The first sample text feature is a text feature of the first sample text, the at least one first sample probability indicates probabilities that the first sample text is translated into various candidate texts in at least one candidate text, the first sample probability corresponding to any candidate text indicates a probability that the first sample text is translated into the any candidate text, and the at least one candidate text is the text in the second language.

For a specific implementation process of operation 402, refer to descriptions of operation 201 in the embodiment in FIG. 2. Details are not described herein again.

Operation 403: Obtain at least one sample data-pair matching the first sample text feature. Any sample data-pair includes one second sample text feature and one second standard translation text.

The second sample text feature is a text feature of a second sample text, the second sample text is the text in the first language, and the second standard translation text is the text in the second language obtained by translating the second sample text.

In some embodiments, that at least one sample data-pair matching the first sample text feature is obtained includes: At least one initial data-pair matching the first sample text feature is retrieved in a data-pair library, any initial data-pair includes one third sample text feature and the second standard translation text, the third sample text feature is the text feature of the second sample text, the second sample text is the text in the first language, and the second standard translation text is the text in the second language obtained by translating the second sample text; and the at least one sample data-pair is determined based on the at least one initial data-pair.

In some embodiments, a manner in which the at least one sample data-pair is determined based on the at least one initial data-pair is: The at least one initial data-pair is used as the at least one sample data-pair. In this case, the third sample text feature of the second sample text in the initial data-pair are directly used as the second sample text feature of the second sample text in the sample data-pair.

In some embodiments, a manner corresponding to determining the at least one sample data-pair based on the at least one initial data-pair is: The at least one initial data-pair is interfered based on an interference probability to obtain an interfered data-pair; and the at least one sample data-pair is determined based on the interfered data-pair.

Since the data-pair library and the first sample text may not exactly match, and the retrieved at least one sample data-pair may not include the first standard translation text, in a phase of training the model, a perturbation may be added to the at least one initial data-pair (that is, the at least one initial data-pair is interfered), to enable the model to be more robust, and increase accuracy of a translation result of the model.

For example, the interference probability may be set empirically. For example, the interference probability may be determined based on a number of updates corresponding to the initial text translation model. For example, the interference probability is inversely correlated with the number of updates corresponding to the initial text translation model. For example, a ratio of the number of updates corresponding to the initial text translation model to a decreased speed of the interference probability is determined, a value inversely correlated with the ratio is determined, and a product of the value and an initial interference probability is used as the interference probability. The initial interference probability and the decreased speed of the interference probability may be set empirically or may be flexibly adjusted based on an application scenario. This is not limited in the embodiment of the present disclosure.

For example, the interference probability may be calculated according to the following Formula (11):

$$α = {α}_{0} * exp ( - step / β ) \qquad Formula ( 11 )$$

α₀ is an initial interference probability. β is a decreased speed of an interference probability. step is a number of updates corresponding to the initial text translation model. α is the interference probability. According to the Formula (11) above, a greater number of updates corresponding to the initial text translation model indicates a smaller interference probability α.

In some embodiments, performing interference on the at least one initial data-pair based on the interference probability refers to performing interference on the at least one initial data-pair with a likelihood of the interference probability and not performing interference on the at least one initial data-pair with a likelihood (1-interference probability).

In some embodiments, the interference probability includes a first interference probability. That the at least one initial data-pair is interfered with based on an interference probability to obtain an interfered data-pair includes: A noise feature is added to the third sample text feature in each initial data-pair based on the first interference probability, to obtain the interfered data-pair. In this case, a manner in which the at least one sample data-pair is determined based on the interfered data-pair is: The interfered data-pair is used as the at least one sample data-pair. The first interference probability is a performing probability of an interference manner of adding the noise feature to the third sample text feature in each data-pair.

For a problem that the data-pair library and the first sample text may not exactly match, the noise feature may be added to the third sample text feature of the retrieved at least one initial data-pair to construct a data-pair with noise. The second sample text feature in the data-pair with noise may be constructed according to the following Formula (12):

$${h}_{k}^{′} = {h}_{k} + ϵ , ϵ \sim N ( 0 , {σ}^{2} I ) \qquad Formula ( 12 )$$

hₖ is a third sample text feature in a retrieved k^{th} initial data-pair. ∈ is a noise feature. The noise feature can be sampled from a Gaussian distribution (N(0, σ²I)), and the noise feature varies randomly. h′ₖ is a second sample text feature in a k^{th} sample data-pair obtained by adding the noise feature.

If the data-pair library and the first sample text do not exactly match, the retrieved at least one initial data-pair does not efficiently help complete training of the model, so that the data-pair library and the first sample text are more matched by adding the noise feature to the third sample text feature of the at least one initial data-pair to enable the second sample text feature to deviate from the third sample text feature of the initial data-pair. In this process, the second standard translation text in each initial data-pair is unchanged.

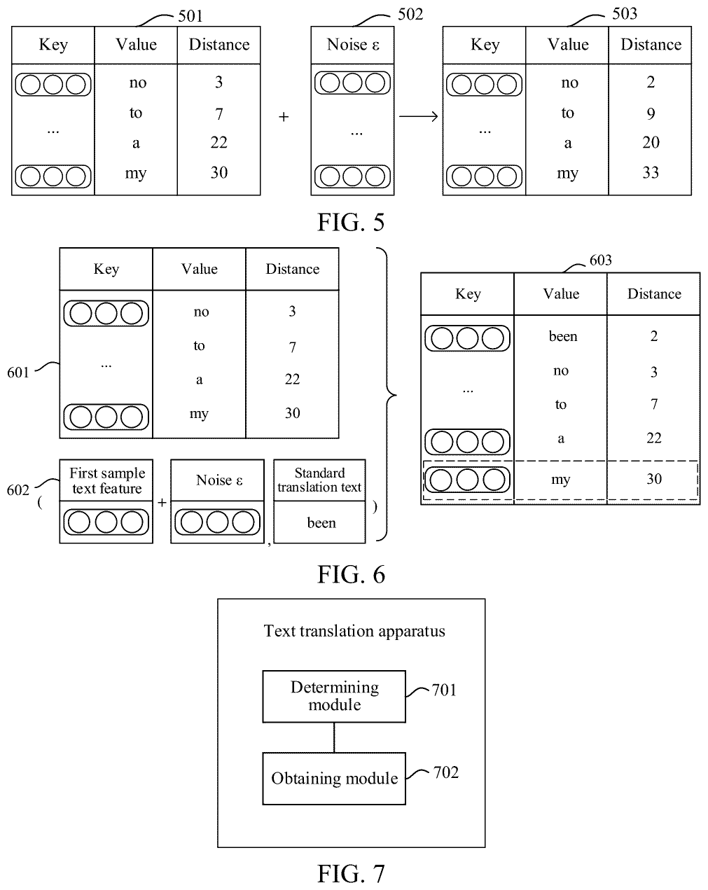

FIG. 5 is a schematic diagram of constructing a data-pair with noise. In FIG. 5, 501 is at least one initial data-pair retrieved in a data-pair library, 502 is an added noise feature, and 503 is a sample data-pair constructed by adding the noise feature.

In some embodiments, the interference probability includes a second interference probability. That the at least one initial data-pair is interfered based on an interference probability to obtain an interfered data-pair includes: Based on the second interference probability, an initial data-pair is culled, that does not satisfy a matching condition in the at least one initial data-pair, to obtain the interfered data-pair. In this case, a manner in which the at least one sample data-pair is determined based on the interfered data-pair is: A reference data-pair is constructed based on the first sample text feature and the first standard translation text, and a number of reference data-pairs is the same as a number of culled initial data-pairs; and the at least one sample data-pair is determined based on the interfered data-pair and the reference data-pair. The second interference probability is a performing probability of an interference manner of culling the initial data-pair that does not satisfy the matching condition in the at least one initial data-pair. For example, the second interference probability may be the same as the first interference probability, or may be different from the first interference probability.

In some embodiments, when the second standard translation text does not include the first standard translation text, the reference data-pair may be constructed based on the first sample text feature and the first standard translation text, to ensure that the first standard translation text is included in the at least one sample data-pair. In some embodiments, Constructing the reference data-pair based on the first sample text feature and the first standard translation text may refer to directly constructing the reference data-pair based on the first sample text feature and the first standard translation text, or may refer to adding the noise feature to the first sample text feature and constructing the reference data-pair based on the sample text feature and the first standard translation text obtained by adding the noise feature.

In some embodiments, determining the at least one sample data-pair based on the interfered data-pair and the reference data-pair refers to using both the interfered data-pair and the reference data-pair as the sample data-pair. In a process of using the interfered data-pair as the sample data-pair, the third sample text feature in the interfered data-pair is used as the second sample text feature in the sample data-pair, and the second standard translation text in the interfered data-pair is used as the second standard translation text in the sample data-pair. In the process of using the reference data-pair as the sample data-pair, the first sample text feature in the sample data-pair or the sample text feature obtained by adding the noise feature to the first sample text feature are used as the second sample text feature in the sample data-pair, and the first standard translation text in the reference data-pair is used as the second standard translation text in the sample data-pair.

FIG. 6 is a schematic diagram of obtaining a sample data-pair. In FIG. 6, 601 is at least one initial data-pair retrieved in a data-pair library, 602 is a reference data-pair constructed based on a first sample text feature and a first standard translation text, and 603 is at least one sample data-pair determined.

In some embodiments, culling, based on the second interference probability, an initial data-pair that does not satisfy a matching condition in the at least one initial data-pair, may refer to culling an initial data-pair, in the at least one initial data-pair, in which a third sample text feature is farthest from the first sample text feature. FIG. 6 shows the culling of the initial data-pair, in the at least one initial data-pair, in which the third sample text feature is farthest from the first sample text feature. In some embodiments, that the matching condition is not satisfied may also be that a distance between the third sample text feature and the first sample text feature is greater than a distance threshold. The distance threshold may be set empirically or flexibly adjusted based on an actual circumstance. This is not limited in the embodiment of the present disclosure.

In some embodiments, that the interference probability includes the first interference probability and the second interference probability, and the at least one initial data-pair is interfered based on the interference probability to obtain the interfered data-pair includes: The noise feature is added to the third sample text feature in each initial data-pair based on the first interference probability to obtain an intermediate data-pair; and based on the second interference probability, a data-pair is culled, that does not satisfy the matching condition in the intermediate data-pair, to obtain the interfered data-pair. In this case, a manner in which the at least one sample data-pair is obtained based on the interfered data-pair is: The reference data-pair is constructed based on the first sample text feature and the first standard translation text, and a number of reference data-pairs is the same as a number of culled data-pairs; and the at least one sample data-pair is determined based on the interfered data-pair and the reference data-pair.

In some embodiments, that the interference probability includes the first interference probability and the second interference probability, and the at least one initial data-pair is interfered with based on the interference probability to obtain the interfered data-pair includes: Based on the second interference probability, the initial data-pair is culled, that does not satisfy the matching condition in the at least one initial data-pair is culled, to obtain an intermediate data-pair; and the noise feature is added to the third sample text feature in the intermediate data-pair based on the first interference probability to obtain the interfered data-pair. In this case, a manner in which the at least one sample data-pair is obtained based on the interfered data-pair is: The reference data-pair is constructed based on the first sample text feature and the first standard translation text, and a number of reference data-pairs is the same as a number of culled data-pairs; and the at least one sample data-pair is determined based on the interfered data-pair and the reference data-pair.

In some embodiments, unlike the process of using the text translation model to obtain the translation text of the first text as shown in FIG. 3, in a process of training the initial text translation model, a specific interference is added to the initial data-pair retrieved from the data-pair library, and the confidence and translation text are determined based on the added interference data-pair, to significantly improve robustness of the model against a noise interference.

Operation 404: Determine confidences and matching degrees of the at least one sample data-pair. A confidence of the any sample data-pair indicates reliability of the any sample data-pair, and a matching degree of the any sample data-pair indicates similarity of the second sample text feature in the any sample data-pair with the first sample text feature.

For an implementation process of operation 404, refer to operation 203 in the embodiment in FIG. 2. Details are not described herein again.

Operation 405: Determine at least one second sample probability based on the confidences and the matching degrees of the at least one sample data-pair.

The at least one second sample probability indicates probabilities that the first sample text is translated into various second standard translation texts in the at least one sample data-pair, and the second sample probability corresponding to the any second standard translation text indicates a probability that the first sample text is translated into the any second standard translation text.

For an implementation process of operation 405, refer to operation 204 in the embodiment in FIG. 2. Details are not described herein again.

Operation 406: Determine, based on the at least one first sample probability and the at least one second sample probability, a predicted translation text corresponding to the first sample text.

For an implementation process of operation 406, refer to operation 205 in the embodiment in FIG. 2. Details are not described herein again.

Operation 407: Update the initial text translation model based on a difference between the predicted translation text and the first standard translation text, to obtain a target text translation model.

In some embodiments, based on the predicted translation text corresponding to the first sample text and the first standard translation text, a resultant loss is obtained. The resultant loss represents a difference between the predicted translation text corresponding to the first sample text and the first standard translation text; and a model parameter of the initial text translation model is updated with the resultant loss, to obtain a target text translation model.

After the predicted translation text corresponding to the first sample text is obtained, the resultant loss is obtained based on the predicted translation text corresponding to the first sample text and the first standard translation text. A manner in which the resultant loss is obtained based on the predicted translation text corresponding to the first sample text and the first standard translation text is not limited in the embodiment of the present disclosure. For example, a cross entropy loss or a mean square error loss between the predicted translation text corresponding to the first sample text and the first standard translation text is used as the resultant loss.

After the resultant loss is obtained, the model parameter of the initial text translation model is updated by using the resultant loss. Updating the model parameter of the initial text translation model by using the resultant loss may refer to updating all model parameters of the initial text translation model by using the resultant loss, or may refer to updating a part of model parameters (for example, model parameters other than the model parameter of the first translation sub-model) of the initial text translation model by using the resultant loss. This is not limited in the embodiment of the present disclosure.

After the model parameter of the initial text translation model is updated by using the resultant loss, a trained text translation model is obtained. Whether the trained text translation model satisfies a training termination condition is determined. If the trained text translation model satisfies the training termination condition, the trained text translation model is used as the target text translation model. If the trained text translation model does not satisfy the training termination condition, the updating of the trained text translation model continues in the manner described with reference to operation 401 to operation 407, and so on, until a text translation model satisfying the training termination condition is obtained, and the text translation model satisfying the training termination condition is used as the target text translation model.

That the training termination condition is satisfied is set empirically, or flexibly adjusted based on an application scenario. This is not limited in the embodiment of the present disclosure. For example, that the trained text translation model satisfies the training termination condition includes, but is not limited to, any one of a number of model parameter updates that are performed reaching a number threshold when the trained text translation model is obtained, the resultant loss being less than a loss threshold when the trained text translation model is obtained, or the resultant loss converging when the trained text translation model is obtained.

In the technical solution provided in the embodiment of the present disclosure, the interference probability is dynamically determined based on the number of updates corresponding to the initial text translation model, and adding the interference probability is more plausible. At the same time, the at least one initial data-pair based on the interference probability is interfered to obtain the interfered data-pair. This can resolve, to some extent, a problem that the data-pair library and the first sample text do not exactly match, and a problem that the retrieved at least one sample data-pair does not include the first standard translation text, to enable the translation result of the model to be more accurate.

In a technical solution provided in this embodiment of the present disclosure, in a process of determining the second sample probability, the confidence of the sample data-pair is considered in addition to the matching degree of the second sample text feature with the first sample text feature in the sample data-pair. Rich information is considered. Additionally, the confidence of the sample data-pair is used to measure reliability of the sample data-pair, and by considering the confidence of the sample data-pair, reliability of the second sample probability can be improved, thereby improving accuracy of a pre-translation text, improving efficiency of obtaining the model and reliability of the obtained model, and further improving accuracy of text translation by using the model.

The text translation method in the embodiment of the present disclosure may be considered to perform text translation based on a k-nearest-neighbor machine translation (kNN-MT) method. kNN-MT is an important direction of research on a neural machine translation task. This method assists in translation generation by retrieving a useful key-value pair from a constructed data-pair library, and in the process, the NMT model does not need to be updated. However, a potential noise sample retrieved can drastically undermine performance of the model. To improve robustness of the model, this embodiment of the present disclosure provides a robust k-nearest-neighbor machine translation model based on a confidence. In particular, since a previous method do not consider the confidence of the NMT model, the embodiment of the present disclosure introduces the confidence of the NMT and a distribution calibration network, and a weight prediction network to optimize a distribution of a k-neighbor prediction and a weight of an inter-distribution interpolated. In addition, a method of training robustness is added in a training process, and includes adding two types of interference to a retrieved result, thereby further improving an ability of the model to resist a noise retrieved result.

The embodiment of the present disclosure adds confidence information of the NMT model to a model structure compared to the previous k-nearest-neighbor machine translation model, to optimize a prediction of the k-nearest-neighbor distribution and an interpolation weight through two networks (a distribution calibration network and a weight prediction network). By considering the confidence information of the NMT model, the model can better balance a weight between the k-nearest-neighbor distribution and the NMT prediction distribution, to avoid that a weight of the k-nearest-neighbor distribution with noise is excessively great to decrease a performance of the model. In addition, two types of interferences are added in the training process to make the model more capable of avoiding an effect of noise on the model in the training process and improve robustness of the model.

Refer to FIG. 7. An embodiment of the present disclosure provides a text translation apparatus, including:

a determining module 701, configured to determine at least one first probability based on a first text feature, where the first text feature is a text feature of a first text, the first text is a text in a first language, the at least one first probability indicates probabilities that the first text is translated into various candidate texts in at least one candidate text, and the at least one candidate text is a text in a second language;

an obtaining module 702, configured to obtain at least one target data-pair matching the first text feature, where any target data-pair includes one second text feature and one standard translation text of a second text, the second text feature is a text feature of the second text, the second text is the text in the first language, and the standard translation text is the text in the second language;

the determining module 701, further configured to determine confidences and matching degrees of the at least one target data-pair, where a confidence of the any target data-pair indicates reliability of the any target data-pair, and a matching degree of the any target data-pair indicates similarity of the second text feature in the any target data-pair with the first text feature;

the determining module 701, further configured to determine at least one second probability based on the confidences and the matching degrees of the at least one target data-pair, where the at least one second probability indicates probabilities that the first text is translated into various standard translation texts in the at least one target data-pair; and

the determining module 701, further configured to determine, based on the at least one first probability and the at least one second probability, a translation text corresponding to the first text.

In some embodiments, the determining module 701 is configured to determine at least one third probability for the any target data-pair of the at least one target data-pair based on the second text feature in the any target data-pair, where the least one third probability indicates probabilities that the second text corresponding to the any target data-pair is translated into the various candidate texts; a fourth probability is determined based on the at least one third probability, where the fourth probability indicates a probability that the second text corresponding to the any target data-pair is translated into the standard translation text in the any target data-pair, and determine the confidence of the any target data-pair based on the fourth probability.

In some embodiments, the determining module 701 is configured to determine a fifth probability based on the at least one first probability, where the fifth probability indicates a probability that the first text is translated into the standard translation text in the any target data-pair, and determine the confidence of the any target data-pair based on the fourth probability and the fifth probability.

In some embodiments, the determining module 701 is configured to normalize a matching degree of a first data-pair for any one of the various standard translation texts, to obtain a normalized matching degree, where the first data-pair is a data-pair that includes the any standard translation text in the at least one target data-pair, calibrate the normalized matching degree by using the confidence of the first data-pair to obtain a calibrated matching degree; and determine, based on the calibrated matching degree, a second probability corresponding to the any standard translation text, where the calibrated matching degree positively correlates with the second probability.

In some embodiments, the determining module 701 is configured to determine a hyperparameter based on at least one piece of information of number indicators of various target data-pairs in the at least one target data-pair and matching degrees of the various target data-pairs, where a number indicator of the any target data-pair is a number of target data-pairs whose arrangement positions are not behind the any target data-pair after the various target data-pairs are arranged in a reference order, and use a ratio of the matching degree of the first data-pair to the hyperparameter as the normalized matching degree.

In some embodiments, the determining module 701 is configured to determine a first probability distribution based on the at least one first probability, determine a second probability distribution based on the at least one second probability, fuse the first probability distribution and the second probability distribution to obtain a fused probability distribution, where the fused probability distribution includes translation probabilities of various target texts, and the various target texts include various candidate texts and various standard translation texts, and use a target text with a maximum translation probability in the various target texts as the translation text.

In some embodiments, the determining module 701 is configured to determine a first importance degree and a second importance degree, where the first importance degree indicates an importance degree of the first probability distribution in a process of obtaining the translation text, the second importance degree indicates the importance degree of the second probability distribution in the process of obtaining the translation text, determine a target parameter based on the first importance degree and the second importance degree, convert the first importance degree based on the target parameter to obtain a first weight, convert the second importance degree based on the target parameter to obtain a second weight, and fuse the first probability distribution and the second probability distribution based on the first weight and the second weight to obtain the fused probability distribution.

In some embodiments, the text translation method is implemented by a target text translation model, and the target text translation model is used to translate the text in the first language into the text in the second language.

In a technical solution provided in an embodiment of the present disclosure, in a process of determining the second probability, the confidence of the target data-pair is considered in addition to the matching degree of the second text feature with the first text feature in the target data-pair. Rich information is considered. Additionally, the confidence of the target data-pair is used to measure reliability of the target data-pair, and by considering the confidence of the target data-pair, reliability of the second probability can be improved, thereby further improving accuracy of text translation.

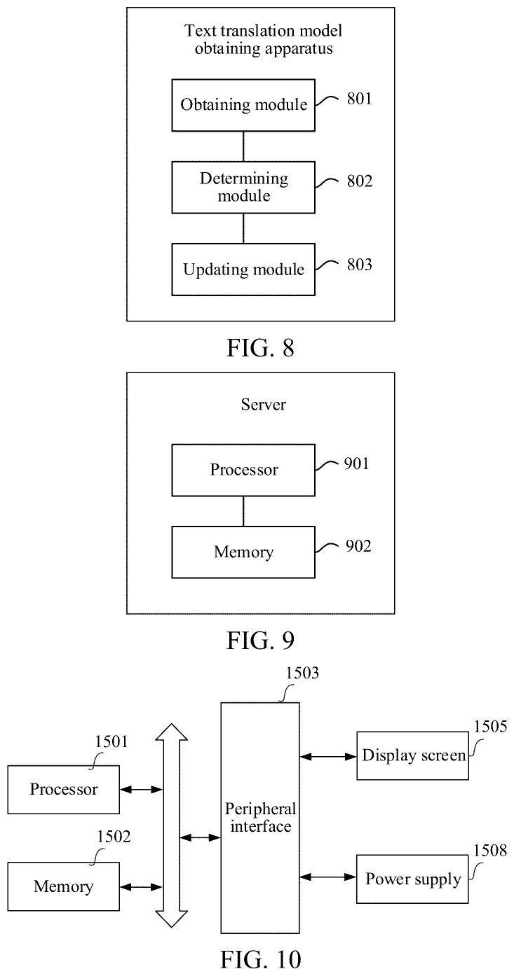

Refer to FIG. 8. This embodiment of the present disclosure provides a text translation model obtaining apparatus, including:

an obtaining module 801, configured to obtain a first sample text, a first standard translation text, and an initial text translation model, where the first sample text is a text in a first language, and the first standard translation text is a text in a second language obtained by translating the first sample text;

a determining module 802, configured to process a first sample text feature by using the initial text translation model to obtain at least one first sample probability, where the first sample text feature is a text feature of first sample text, the at least one first sample probability indicates probabilities that the first sample text is translated into various candidate texts in at least one candidate text, and the at least one candidate text is the text in the second language;

the obtaining module 801, further configured to obtain at least one sample data-pair matching the first sample text feature, where any sample data-pair includes one second sample text feature and one second standard translation text, the second sample text feature is a text feature of a second sample text, the second sample text is the text in the first language, and the second standard translation text is the text in the second language obtained by translating the second sample text;

the determining module 802, further configured to determine confidences and matching degrees of the at least one sample data-pair, where a confidence of the any sample data-pair indicates reliability of the any sample data-pair, and a matching degree of the any sample data-pair indicates similarity of the second sample text feature in the any sample data-pair with the first sample text feature;

the determining module 802, further configured to determine at least one second sample probability based on the confidences and the matching degrees of the at least one sample data-pair, where the at least one second sample probability indicates probabilities that the first sample text is translated into various second standard translation texts in the at least one sample data-pair;

the determining module 802, further configured to determine, based on the at least one first sample probability and the at least one second sample probability, a predicted translation text corresponding to the first sample text; and

an updating module 803, configured to update the initial text translation model based on a difference between the predicted translation text and the first standard translation text, to obtain a target text translation model.

In some embodiments, the obtaining module 801 is configured to:

retrieve, in a data-pair library, at least one initial data-pair matching the first sample text feature, where any initial data-pair includes one third sample text feature and the second standard translation text, the third sample text feature is the text feature of the second sample text, the second sample text is the text in the first language, the second standard translation text is the text in the second language obtained by translating the second sample text; and

perform interference on the at least one initial data-pair based on an interference probability to obtain an interfered data-pair; and

determine the at least one sample data-pair based on the interfered data-pair.

In some embodiments, the interference probability is determined based on a number of updates of the initial text translation model, and the interference probability is inversely correlated with the number of updates of the initial text translation model.

In some embodiments, the interference probability includes a first interference probability, the first interference probability indicates a performing probability of adding noise as an interference manner; and the obtaining module 801 is configured to add a noise feature to a third sample text feature in each initial data-pair based on the first interference probability to obtain the interfered data-pair, and use the interfered data-pair as the at least one sample data-pair.

In some embodiments, the interference probability includes a second interference probability, where the second interference probability indicates a performing probability of culling the initial data-pair as an interference manner; and the obtaining module 801 is configured to cull, based on the second interference probability, an initial data-pair that does not satisfy a matching condition in the at least one initial data-pair, to obtain the interfered data-pair, construct a reference data-pair based on the first sample text feature and the first standard translation text, where a number of reference data-pairs is the same as a number of culled initial data-pairs, and determine the at least one sample data-pair based on the interfered data-pair and the reference data-pair.

In a technical solution provided in an embodiment of the present disclosure, in a process of determining the second sample probability, the confidence of the sample data-pair is considered in addition to the matching degree of the second sample text feature with the first sample text feature in the sample data-pair. Rich information is considered. Additionally, the confidence of the sample data-pair is used to measure reliability of the sample data-pair, and by considering the confidence of the sample data-pair, reliability of the second sample probability can be improved, thereby improving accuracy of a pre-translation text, improving efficiency of obtaining the model and reliability of the obtained model, and further improving accuracy of text translation by using the model.

When the apparatus provided in the foregoing embodiments implements the functions of the apparatus, only division of the foregoing functional modules is used as an example for description. In the practical application, the functions may be allocated to and completed by different functional modules based on requirements. That is, an internal structure of the device is divided into different functional modules, to complete all or some of the functions described above. In addition, the apparatus provided in the foregoing embodiments and the method embodiments fall within a same conception. For details of a specific implementation process, refer to the method embodiments. Details are not described herein again.

In some embodiments, a computer device is further provided. The computer device includes: a processor and a memory, and the memory has at least one computer program stored therein. The at least one computer program is loaded and executed by one or more processors to enable the computer device to implement any one of the text translation method or the text translation model obtaining method described above. The computer device may be a server or a terminal, and this is not limited in the embodiment of the present disclosure. Next, structures of the server and the terminal are described separately.

FIG. 9 is a schematic diagram of a structure of a server according to an embodiment of the present disclosure. The server may vary greatly based on configurations or performances, and may include one or more central processing units (CPU) 901 and one or more memories 902. The one or more memories 902 have at least one computer program stored therein, and the at least one computer program is loaded and executed by the one or more processors 901, to enable the server to implement the text translation method or the text translation model obtaining method provided in each method embodiment described above. Certainly, the server may further have components such as a wired or wireless network interface, a keyboard, and an input/output interface, to facilitate input and output. The server may further include another component configured to implement a function of a device. Details are not described herein again.

FIG. 10 is a schematic diagram of a structure of a terminal according to an embodiment of the present disclosure. The terminal may be: personal computers (PC), cell phones, smart phones, personal digital assistants (PDA), wearable devices, pocket personal computers (PPC), tablet computers, smart cars, smart televisions, smart sound boxes, smart voice interactive devices, smart appliances, in-vehicle terminal, virtual reality (VR) devices, augmented reality (AR) devices. The terminal may also be referred to as another name such as user equipment, a portable terminal, a laptop terminal, or a desktop terminal.

Generally, the terminal includes: a processor 1501 and a memory 1502.

The processor 1501 may include one or more processing cores, for example, a 4-core processor or an 8-core processor. The processor 1501 may be implemented in at least one hardware form of a digital signal processor (DSP), a field-programmable gate array (FPGA), and a programmable logic array (PLA). The processor 1501 may also include a main processor and a coprocessor. The main processor is a processor configured to process data in an awake state, and is also referred to as a central processing unit (CPU). The coprocessor is a low power processor for processing data in a standby state. In some embodiments, the processor 1501 may be integrated with a graphics processing unit (GPU). The graphics processing unit (GPU) is configured to render and draw content that needs to be displayed on a display screen. In some embodiments, the processor 1501 may further include an artificial intelligence (AI) processor. The AI processor is configured to process computing operations related to machine learning.

The memory 1502 may include one or more computer-readable storage media. The computer-readable storage medium may be non-transient. The memory 1502 may further include a high-speed random access memory and a nonvolatile memory, for example, one or more disk storage devices or flash storage devices. In some embodiments, the non-transitory computer-readable storage medium in the memory 1502 is configured to store at least one instruction, and the at least one instruction is configured to be executed by the processor 1501 to enable the terminal to implement the text translation method and the text translation model obtaining method provided in embodiments of the present disclosure.

In some embodiments, the terminal further may include: a peripheral interface 1503 and at least one peripheral. The processor 1501, the memory 1502, and the peripheral interface 1503 may be connected through a bus or a signal cable. Each peripheral may be connected to the peripheral interface 1503 through a bus, a signal cable, or a circuit board. Specifically, the peripheral includes: at least one of a display screen 1505 and a power supply 1508.

The peripheral interface 1503 may be configured to connect the at least one peripheral related to input/output (I/O) to the processor 1501 and the memory 1502. In some embodiments, the processor 1501, the memory 1502, and the peripheral interface 1503 are integrated on the same chip or circuit board. In some other embodiments, any one or two of the processor 1501, the memory 1502, and the peripheral interface 1503 may be implemented on a single chip or circuit board. This is not limited in this embodiment.

The display screen 1505 is configured to display a user interface (UI). The user interface (UI) may include a graph, text, an icon, a video, and any combination thereof. When the display screen 1505 is a touch display screen, the display screen 1505 further has a capability of collecting a touch signal on or above a surface of the display screen 1505. The touch signal may be inputted to the processor 1501 as a control signal for processing. In this case, the display screen 1505 may be further configured to provide a virtual button and/or a virtual keyboard that are/is also referred to as a soft button and/or a soft keyboard. In some embodiments, the display screen 1505 may be one, disposed on a front panel of the terminal; In some other embodiments, the display screens 1505 may be at least two, each disposed on a different surface of the terminal or in a folded design. In some other embodiments, the display screen 1505 may be a flexible display screen, disposed on a curved surface or on a folded surface of the terminal. Even, the display screen 1505 may be further set in a non-rectangular irregular pattern, namely, a special-shaped screen. The display screen 1505 may be prepared by using materials such as a liquid crystal display (LCD), an organic light-emitting diode (OLED), or the like.

The power supply 1508 is configured to supply power to components in the terminal. The power supply 508 may be an alternating current, a direct current, a primary battery, or a rechargeable battery. When the power supply 1508 includes the rechargeable battery, the rechargeable battery may support wired charging or wireless charging. The rechargeable battery may be further configured to support a fast charging technology.

A person skilled in the art may understand that the structure shown in FIG. 10 constitutes no limitation on the terminal, and the terminal may include more or fewer components than those shown in the figure, or some components may be combined, or a different component deployment may be used.

Embodiments of the present disclosure further provide a computer-readable storage medium. The computer-readable storage medium has at least one computer program stored therein, and the at least one computer program is loaded and executed by a processor of a computer device, to enable a computer to implement any one of the text translation method or the text translation model obtaining method above.

In some embodiments, the computer-readable storage medium may be a read-only memory (ROM), a RAM, a compact disc ROM (CD-ROM), a magnetic tape, a floppy disk, an optical data storage device, or the like.

In some embodiments, a computer program product is further provided, and the computer program product includes a computer program or computer instructions. The computer program or computer instructions are loaded and executed by a processor, to enable a computer to implement any one of the text translation method or the text translation model obtaining method described above.

The foregoing descriptions are merely exemplary embodiments of the present disclosure, but are not intended to limit the present disclosure. Any modification, equivalent replacement, or improvement made within the principle of the present disclosure shall fall within the protection scope of the present disclosure.

What is claimed is:

1. A text translation method, applied to a computer device, the method comprising:
determining at least one first probability based on a first text feature, the first text feature being a text feature of a first text, the first text being a text in a first language, the at least one first probability indicating probabilities that the first text is translated into various candidate texts of at least one candidate text, and the at least one candidate text being a text in a second language;
obtaining at least one target data-pair matching the first text feature, a target data-pair comprising one second text feature and one standard translation text of a second text, the second text feature being a text feature of the second text, the second text being the text in the first language, and the standard translation text being the text in the second language;
determining confidences and matching degrees of the at least one target data-pair, a confidence of the target data-pair indicating reliability of the target data-pair, and a matching degree of the target data-pair indicating similarity of the second text feature in the target data-pair with the first text feature;
determining at least one second probability based on the confidences and the matching degrees of the at least one target data-pair, the at least one second probability indicating probabilities that the first text is translated into various standard translation texts in the at least one target data-pair; and
determining, based on the at least one first probability and the at least one second probability, a translation text corresponding to the first text.

2. The method according to claim 1, wherein determining the confidences of the at least one target data-pair comprises:
determining at least one third probability for the target data-pair of the at least one target data-pair based on the second text feature in the target data-pair, wherein the least one third probability indicates probabilities that the second text corresponding to the target data-pair is translated into the various candidate texts;
determining a fourth probability based on the at least one third probability, wherein the fourth probability indicates a probability that the second text corresponding to the target data-pair is translated into the standard translation text in the target data-pair; and
determining the confidence of the target data-pair based on the fourth probability.

3. The method according to claim 2, wherein determining the confidence of the target data-pair based on the fourth probability comprises:
determining a fifth probability based on the at least one first probability, wherein the fifth probability indicates a probability that the first text is translated into the standard translation text in the target data-pair; and
determining the confidence of the target data-pair based on the fourth probability and the fifth probability.

4. The method according to claim 1, wherein determining the at least one second probability based on the confidences and the matching degrees of the at least one target data-pair comprises:
normalizing a matching degree of a first data-pair for any one of the various standard translation texts, to obtain a normalized matching degree, wherein the first data-pair is a data-pair that comprises the standard translation text in the at least one target data-pair;
calibrating the normalized matching degree by using the confidence of the first data-pair to obtain a calibrated matching degree; and
determining, based on the calibrated matching degree, a second probability corresponding to the standard translation text, wherein the calibrated matching degree positively correlates with the second probability.

5. The method according to claim 4, wherein normalizing the matching degree of the first data-pair to obtain the normalized matching degree comprises:
determining a hyperparameter based on at least one piece of information of number indicators of various target data-pairs in the at least one target data-pair and matching degrees of the various target data-pairs, wherein a number indicator of the target data-pair is a number of target data-pairs whose arrangement positions are not behind the target data-pair after the various target data-pairs are arranged in a reference order; and
using a ratio of the matching degree of the first data-pair to the hyperparameter as the normalized matching degree.

6. The method according to claim 1, wherein determining, based on the at least one first probability and the at least one second probability, the translation text corresponding to the first text comprises:
determining a first probability distribution based on the at least one first probability;
determining a second probability distribution based on the at least one second probability;
fusing the first probability distribution and the second probability distribution to obtain a fused probability distribution, wherein the fused probability distribution comprises translation probabilities of various target texts, and the various target texts comprise various candidate texts and various standard translation texts; and
using a target text with a maximum translation probability in the various target texts as the translation text.

7. The method according to claim 6, wherein fusing the first probability distribution and the second probability distribution to obtain the fused probability distribution comprises:
determining a first importance degree and a second importance degree, wherein the first importance degree indicates an importance degree of the first probability distribution in a process of obtaining the translation text, and the second importance degree indicates an importance degree of the second probability distribution in the process of obtaining the translation text;
determining a target parameter based on the first importance degree and the second importance degree;
converting the first importance degree based on the target parameter to obtain a first weight;
converting the second importance degree based on the target parameter to obtain a second weight; and
fusing the first probability distribution and the second probability distribution based on the first weight and the second weight to obtain the fused probability distribution.

8. The method according to claim 1, being implemented by a target text translation model, wherein the target text translation model is used to translate the text in the first language into the text in the second language.

9. A computer device, comprising one or more processors and a memory containing at least one computer program that, when being executed, causes the one or more processors to perform:
determining at least one first probability based on a first text feature, the first text feature being a text feature of a first text, the first text being a text in a first language, the at least one first probability indicating probabilities that the first text is translated into various candidate texts of at least one candidate text, and the at least one candidate text being a text in a second language;
obtaining at least one target data-pair matching the first text feature, a target data-pair comprising one second text feature and one standard translation text of a second text, the second text feature being a text feature of the second text, the second text being the text in the first language, and the standard translation text being the text in the second language;
determining confidences and matching degrees of the at least one target data-pair, a confidence of the target data-pair indicating reliability of the target data-pair, and a matching degree of the target data-pair indicating similarity of the second text feature in the target data-pair with the first text feature;
determining at least one second probability based on the confidences and the matching degrees of the at least one target data-pair, the at least one second probability indicating probabilities that the first text is translated into various standard translation texts in the at least one target data-pair; and
determining, based on the at least one first probability and the at least one second probability, a translation text corresponding to the first text.

10. The device according to claim 9, wherein the one or more processors are further configured to perform:
determining at least one third probability for the target data-pair of the at least one target data-pair based on the second text feature in the target data-pair, wherein the least one third probability indicates probabilities that the second text corresponding to the target data-pair is translated into the various candidate texts;
determining a fourth probability based on the at least one third probability, wherein the fourth probability indicates a probability that the second text corresponding to the target data-pair is translated into the standard translation text in the target data-pair; and
determining the confidence of the target data-pair based on the fourth probability.

11. The device according to claim 10, wherein the one or more processors are further configured to perform:
determining a fifth probability based on the at least one first probability, wherein the fifth probability indicates a probability that the first text is translated into the standard translation text in the target data-pair; and
determining the confidence of the target data-pair based on the fourth probability and the fifth probability.

12. The device according to claim 9, wherein the one or more processors are further configured to perform:
normalizing a matching degree of a first data-pair for any one of the various standard translation texts, to obtain a normalized matching degree, wherein the first data-pair is a data-pair that comprises the standard translation text in the at least one target data-pair;
calibrating the normalized matching degree by using the confidence of the first data-pair to obtain a calibrated matching degree; and
determining, based on the calibrated matching degree, a second probability corresponding to the standard translation text, wherein the calibrated matching degree positively correlates with the second probability.

13. The device according to claim 12, wherein the one or more processors are further configured to perform:
determining a hyperparameter based on at least one piece of information of number indicators of various target data-pairs in the at least one target data-pair and matching degrees of the various target data-pairs, wherein a number indicator of the target data-pair is a number of target data-pairs whose arrangement positions are not behind the target data-pair after the various target data-pairs are arranged in a reference order; and
using a ratio of the matching degree of the first data-pair to the hyperparameter as the normalized matching degree.

14. The device according to claim 9, wherein the one or more processors are further configured to perform:
determining a first probability distribution based on the at least one first probability;
determining a second probability distribution based on the at least one second probability;
fusing the first probability distribution and the second probability distribution to obtain a fused probability distribution, wherein the fused probability distribution comprises translation probabilities of various target texts, and the various target texts comprise various candidate texts and various standard translation texts; and
using a target text with a maximum translation probability in the various target texts as the translation text.

15. The device according to claim 14, wherein the one or more processors are further configured to perform:
determining a first importance degree and a second importance degree, wherein the first importance degree indicates an importance degree of the first probability distribution in a process of obtaining the translation text, and the second importance degree indicates an importance degree of the second probability distribution in the process of obtaining the translation text;
determining a target parameter based on the first importance degree and the second importance degree;
converting the first importance degree based on the target parameter to obtain a first weight;
converting the second importance degree based on the target parameter to obtain a second weight; and
fusing the first probability distribution and the second probability distribution based on the first weight and the second weight to obtain the fused probability distribution.

16. The device according to claim 9, wherein the one or more processors are further configured to use a target text translation model to translate the text in the first language into the text in the second language.

17. A non-transitory computer-readable storage medium containing at least one computer program that, when being executed, causes a computer to perform:
determining at least one first probability based on a first text feature, the first text feature being a text feature of a first text, the first text being a text in a first language, the at least one first probability indicating probabilities that the first text is translated into various candidate texts of at least one candidate text, and the at least one candidate text being a text in a second language;
obtaining at least one target data-pair matching the first text feature, a target data-pair comprising one second text feature and one standard translation text of a second text, the second text feature being a text feature of the second text, the second text being the text in the first language, and the standard translation text being the text in the second language;
determining confidences and matching degrees of the at least one target data-pair, a confidence of the target data-pair indicating reliability of the target data-pair, and a matching degree of the target data-pair indicating similarity of the second text feature in the target data-pair with the first text feature;
determining at least one second probability based on the confidences and the matching degrees of the at least one target data-pair, the at least one second probability indicating probabilities that the first text is translated into various standard translation texts in the at least one target data-pair; and
determining, based on the at least one first probability and the at least one second probability, a translation text corresponding to the first text.

18. The storage medium according to claim 17, wherein the computer is further configured to perform:
determining at least one third probability for the target data-pair of the at least one target data-pair based on the second text feature in the target data-pair, wherein the least one third probability indicates probabilities that the second text corresponding to the target data-pair is translated into the various candidate texts;
determining a fourth probability based on the at least one third probability, wherein the fourth probability indicates a probability that the second text corresponding to the target data-pair is translated into the standard translation text in the target data-pair; and
determining the confidence of the target data-pair based on the fourth probability.

19. The storage medium according to claim 18, wherein the computer is further configured to perform:
determining a fifth probability based on the at least one first probability, wherein the fifth probability indicates a probability that the first text is translated into the standard translation text in the target data-pair; and
determining the confidence of the target data-pair based on the fourth probability and the fifth probability.

20. The storage medium according to claim 17, wherein the computer is further configured to perform:
normalizing a matching degree of a first data-pair for any one of the various standard translation texts, to obtain a normalized matching degree, wherein the first data-pair is a data-pair that comprises the standard translation text in the at least one target data-pair;
calibrating the normalized matching degree by using the confidence of the first data-pair to obtain a calibrated matching degree; and
determining, based on the calibrated matching degree, a second probability corresponding to the standard translation text, wherein the calibrated matching degree positively correlates with the second probability.
